(19) United States
(12) Patent Application Publication
(10) Pub. No.: US 2023/0361948 A1
(43) Pub. Date: Nov. 9, 2023

(54) MULTI-TRANSMISSION RECEPTION POINT TRANSMISSION SCHEMES WITH PARTIALLY OVERLAPPING RESOURCES

(71) Applicant: QUALCOMM INCORPORATED, San Diego, CA (US)

(72) Inventors: Sourjya Dutta, San Diego, CA (US); Kapil Gulati, Belle Mead, NJ (US); Junyi Li, Fairless Hills, PA (US); Shuanshuan Wu, San Diego, CA (US); Hui Guo, Beijing (CN)

(21) Appl. No.: 18/246,026

(22) PCT Filed: Nov. 6, 2020
(86) PCT No.: PCT/CN2020/127177

§ 371 Date: Mar. 20, 2023

(51) Int. Cl. H04L 5/00; H04B 7/024

(52) U.S. Cl. CPC H04L 5/0035; H04L 5/0023; H04B 7/024

(57) ABSTRACT

Methods, systems, and devices for wireless communications are described. Some wireless communication system support communications between user equipment (UEs). In the examples, a UE may include two or more transmission reception points (TRPs) and may transmit two or more packets on partially or fully overlapping resources via individual TRPs of the two or more TRPs. The UE may identify a first data packet for transmission using a first spatial layer associated with a first TRP and a second data packet for transmission using a second spatial layer associated with a second TRP. The UE may map a portion of the first data packet to a set of resources of the second spatial layer and transmitting a control message indicating that the portion of the first data packet is mapped to the second spatial layer.

### CROSS REFERENCE

The present Application is a 371 national stage filing of International PCT Application No. PCT/CN2020/127177 by Dutta et al. entitled “MULTI-TRANSMISSION RECEPTION POINT TRANSMISSION SCHEMES WITH PARTIALLY OVERLAPPING RESOURCES,” filed Nov. 6, 2020, which is assigned to the assignee hereof, and which is expressly incorporated by reference in its entirety herein.

### FIELD OF TECHNOLOGY

The following relates to wireless communications, including multi-transmission reception point (TRP) transmission schemes with partially overlapping resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may include multiple transmission reception points (TRPs) separated by some distance such that the UE may support simultaneous space-division multiplexing (SDM) transmissions. In some examples, the UE may determine to SDM two or more packets transmitted via two or more different TRPs. In such cases, the UE may map two packets to two separate spatial layers, where each spatial layer corresponds to a different TRP. The mapping, however, may result in unused resources on one or more of the spatial layers, which may reduce overall network efficiency, among other issues.

### SUMMARY

The described techniques relate to improved methods, systems, devices, and apparatuses that support multi-transmission reception point (TRP) transmission schemes with partially overlapping resources. Generally, the described techniques provide for a multi-TRP UE (or other wireless device) to transmit two or more packets using two or more TRPs over resources that are partially or fully overlapping in time, frequency, or both. For instance, a UE may determine to transmit two packets via two different TRPs in the same TTI, where each TRP may correspond to a different spatial layer in a spatial division multiplexing (SDM) scheme. In some examples, a first packet may be allocated a larger number of frequency resources in a first spatial layer as compared to a second packet for a second spatial layer, which may result in unused frequency resources (e.g., resources such as physical resource blocks (PRBs) or subchannels) in the second spatial layer. In such cases, the UE may determine a portion of the first packet to transmit with the second packet in the second spatial layer. That is, the UE may map the first packet to a first spatial layer associated with a first TRP and map the second packet as well as the portion of the first packet to a second spatial layer associated with a second TRP. The UE may utilize at least a portion of the unused frequency resources for mapping of the portion of the first packet, which may increase efficiency and reception reliability.

A method for wireless communications at a user equipment (UE) is described. The method may include identifying a first data packet for transmission using a first spatial layer and a second data packet for transmission using a second spatial layer, the first spatial layer associated with a first transmission reception point of the UE and the second spatial layer associated with a second transmission reception point of the UE, mapping a portion of the first data packet to a set of resources of the second spatial layer, the set of resources at least partially overlapping in time with resources allocated to the first spatial layer, and transmitting a control message indicating that the portion of the first data packet is mapped to the second spatial layer.

An apparatus for wireless communications at a UE is described. The apparatus may include a processor, memory in electronic communication with the processor, and instructions stored in the memory. The instructions may be executable by the processor to cause the apparatus to identify a first data packet for transmission using a first spatial layer and a second data packet for transmission using a second spatial layer, the first spatial layer associated with a first transmission reception point of the UE and the second spatial layer associated with a second transmission reception point of the UE, map a portion of the first data packet to a set of resources of the second spatial layer, the set of resources at least partially overlapping in time with resources allocated to the first spatial layer, and transmit a control message indicating that the portion of the first data packet is mapped to the second spatial layer.

Another apparatus for wireless communications at a UE is described. The apparatus may include means for identifying a first data packet for transmission using a first spatial layer and a second data packet for transmission using a second spatial layer, the first spatial layer associated with a first transmission reception point of the UE and the second spatial layer associated with a second transmission reception point of the UE, means for mapping a portion of the first data packet to a set of resources of the second spatial layer, the set of resources at least partially overlapping in time with resources allocated to the first spatial layer, and means for transmitting a control message indicating that the portion of the first data packet is mapped to the second spatial layer.

A non-transitory computer-readable medium storing code for wireless communications at a UE is described. The code may include instructions executable by a processor to identify a first data packet for transmission using a first spatial layer and a second data packet for transmission using a second spatial layer, the first spatial layer associated with a first transmission reception point of the UE and the second spatial layer associated with a second transmission reception point of the UE, map a portion of the first data packet to a set of resources of the second spatial layer, the set of resources at least partially overlapping in time with resources allocated to the first spatial layer, and transmit a control message indicating that the portion of the first data packet is mapped to the second spatial layer.

In some examples of the method, apparatuses, and non-transitory computer-readable medium described herein, transmitting the control message may include operations, features, means, or instructions for transmitting a common control message via both the first spatial layer and the second spatial layer, the common control message indicating that the resources allocated to the first spatial layer may be the same as resources allocated to the second spatial layer.

In some examples of the method, apparatuses, and non-transitory computer-readable medium described herein, transmitting the control message may include operations, features, means, or instructions for transmitting a common control message via each of the first spatial layer and the second spatial layer, the common control message indicating the set of resources of the second spatial layer being the same as a subset of the resources allocated to the first spatial layer.

In some examples of the method, apparatuses, and non-transitory computer-readable medium described herein, transmitting the control message may include operations, features, means, or instructions for transmitting a sidelink control message indicating that a part of the second spatial layer may be a repetition of a part of the first spatial layer, where the part of the second spatial layer may be associated with the set of resources.

In some examples of the method, apparatuses, and non-transitory computer-readable medium described herein, transmitting the control message may include operations, features, means, or instructions for transmitting a sidelink control message indicating that at least one subchannel of the second spatial layer corresponding to the set of resources includes a repetition of a subchannel of the first spatial layer, where the subchannel corresponds to the portion of the first data packet.

In some examples of the method, apparatuses, and non-transitory computer-readable medium described herein, transmitting the control message may include operations, features, means, or instructions for transmitting a sidelink control message indicating that a subchannel of the second spatial layer contains the mapped portion of the first data packet.

Some examples of the method, apparatuses, and non-transitory computer-readable medium described herein may further include operations, features, means, or instructions for transmitting the first data packet via the first spatial layer in a transmission time interval, transmitting the second data packet via the second spatial layer in the transmission time interval, and transmitting the portion of the first data packet via the second spatial layer in the transmission time interval.

Some examples of the method, apparatuses, and non-transitory computer-readable medium described herein may further include operations, features, means, or instructions for performing a channel sensing procedure on the first spatial layer and determining the portion of the first data packet for mapping to the second spatial layer based on the channel sensing procedure.

In some examples of the method, apparatuses, and non-transitory computer-readable medium described herein, the portion of the first data packet determined for mapping to the second spatial layer corresponds to a subchannel of the first spatial layer associated with a highest interference measurement based on the channel sensing procedure.

Some examples of the method, apparatuses, and non-transitory computer-readable medium described herein may further include operations, features, means, or instructions for determining the portion of the first data packet for mapping, where the first portion of the data packet corresponds to a first subchannel of the first spatial layer different from a second subchannel of the first spatial layer that may be allocated for transmission of the control message.

Some examples of the method, apparatuses, and non-transitory computer-readable medium described herein may further include operations, features, means, or instructions for appending the portion of the first data packet to the second data packet before transmission of the first and second data packets.

In some examples of the method, apparatuses, and non-transitory computer-readable medium described herein, transmitting the control message may include operations, features, means, or instructions for transmitting a sidelink control message indicating a boundary between the second data packet and the portion of the first data packet based on the appending.

In some examples of the method, apparatuses, and non-transitory computer-readable medium described herein, the boundary may be indicated via a medium access control (MAC) control element (MAC-CE).

Some examples of the method, apparatuses, and non-transitory computer-readable medium described herein may further include operations, features, means, or instructions for generating an error correction or detection code of the second data packet and the appended portion of the first data packet and transmitting a message via the second spatial layer that includes the second data packet, the appended portion of the first data packet, and the error correction or detection code.

Some examples of the method, apparatuses, and non-transitory computer-readable medium described herein may further include operations, features, means, or instructions for generating a first error correction or detection code for the portion of the first data packet, generating a second error correction or detection code for the second data packet, appending the portion of the first data packet and the first error correction or detection code to the second data packet and the second error correction or detection code, and transmitting a message via the second spatial layer that includes the second data packet, the second error correction or detection code, the appended portion of the first data packet, and the appended first error correction or detection code.

Some examples of the method, apparatuses, and non-transitory computer-readable medium described herein may further include operations, features, means, or instructions for generating a combined error correction or detection code for a combination of the second data packet, the second error correction or detection code, the appended portion of the first data packet, and the appended first error correction or detection code, where the message includes the combined error correction or detection code.

Some examples of the method, apparatuses, and non-transitory computer-readable medium described herein may further include operations, features, means, or instructions for transmitting an indication of a presence or absence of an error correction or detection code for the portion of the first data packet.

Some examples of the method, apparatuses, and non-transitory computer-readable medium described herein may further include operations, features, means, or instructions for mapping a set of reference signal symbols across all resources allocated to the first spatial layer and all resources allocated to the second spatial layer.

Some examples of the method, apparatuses, and non-transitory computer-readable medium described herein may further include operations, features, means, or instructions for mapping a first reference signal to a subset of the resources allocated to the first spatial layer according to a first reference signal pattern for the first spatial layer and mapping a second reference signal to resources allocated to the second spatial layer including the set of resources according to a second reference signal pattern for the second spatial layer.

Some examples of the method, apparatuses, and non-transitory computer-readable medium described herein may further include operations, features, means, or instructions for determining a first packet size of the first data packet for transmission using the first spatial layer based on a first modulation and coding scheme associated with the first data packet, determining a second packet size of the second data packet for transmission using the second spatial layer based on a second modulation and coding scheme associated with the second data packet, and determining to map the portion of the first data packet to the second spatial layer based on the first packet size being greater than the second packet size.

Some examples of the method, apparatuses, and non-transitory computer-readable medium described herein may further include operations, features, means, or instructions for determining a first number of subchannels for transmission of the first data packet using the first spatial layer, determining a second number of subchannels for transmission of the second data packet using the second spatial layer, and determining to map the portion of the first data packet to the second spatial layer based on the first number of subchannels being greater than the second number of subchannels.

A method for wireless communications at a first UE is described. The method may include receiving, from a second UE, an indication that a portion of a first data packet for transmission to the first UE is mapped to a second spatial layer, the first spatial layer associated with a first transmission reception point of the second UE and the second spatial layer associated with a second transmission reception point of the second UE, monitoring a set of resources of the second spatial layer for the portion of the first data packet, a second data packet, or both, where the set of resources at least partially overlaps resources allocated to the first spatial layer in time, and transmitting a feedback message for the portion of the first data packet or the second data packet based on monitoring the set of resources.

An apparatus for wireless communications at a first UE is described. The apparatus may include a processor, memory in electronic communication with the processor, and instructions stored in the memory. The instructions may be executable by the processor to cause the apparatus to receive, from a second UE, an indication that a portion of a first data packet for transmission to the first UE is mapped to a second spatial layer, the first spatial layer associated with a first transmission reception point of the second UE and the second spatial layer associated with a second transmission reception point of the second UE, monitor a set of resources of the second spatial layer for the portion of the first data packet, a second data packet, or both, where the set of resources at least partially overlaps resources allocated to the first spatial layer in time, and transmit a feedback message for the portion of the first data packet or the second data packet based on monitoring the set of resources.

Another apparatus for wireless communications at a first UE is described. The apparatus may include means for receiving, from a second UE, an indication that a portion of a first data packet for transmission to the first UE is mapped to a second spatial layer, the first spatial layer associated with a first transmission reception point of the second UE and the second spatial layer associated with a second transmission reception point of the second UE, means for monitoring a set of resources of the second spatial layer for the portion of the first data packet, a second data packet, or both, where the set of resources at least partially overlaps resources allocated to the first spatial layer in time, and means for transmitting a feedback message for the portion of the first data packet or the second data packet based on monitoring the set of resources.

A non-transitory computer-readable medium storing code for wireless communications at a first UE is described. The code may include instructions executable by a processor to receive, from a second UE, an indication that a portion of a first data packet for transmission to the first UE is mapped to a second spatial layer, the first spatial layer associated with a first transmission reception point of the second UE and the second spatial layer associated with a second transmission reception point of the second UE, monitor a set of resources of the second spatial layer for the portion of the first data packet, a second data packet, or both, where the set of resources at least partially overlaps resources allocated to the first spatial layer in time, and transmit a feedback message for the portion of the first data packet or the second data packet based on monitoring the set of resources.

In some examples of the method, apparatuses, and non-transitory computer-readable medium described herein, transmitting the feedback message may include operations, features, means, or instructions for transmitting a negative acknowledgement message based on an unsuccessful decoding of the first layer.

Some examples of the method, apparatuses, and non-transitory computer-readable medium described herein may further include operations, features, means, or instructions for storing the portion of the first data packet received using the second spatial layer and receiving a retransmission of the first data packet via the second transmission reception point of the second UE.

Some examples of the method, apparatuses, and non-transitory computer-readable medium described herein may further include operations, features, means, or instructions for receiving the first data packet using the first spatial layer and combining, as part of a decoding procedure of the first data packet, the first data packet with the portion of the first data packet received using the second spatial layer.

Some examples of the method, apparatuses, and non-transitory computer-readable medium described herein may further include operations, features, means, or instructions for dropping the portion of the first data packet via the set of resources of the second spatial layer, where the feedback message may be transmitted based on a result of a decoding procedure of the second data packet received using the second spatial layer.

In some examples of the method, apparatuses, and non-transitory computer-readable medium described herein, receiving the indication may include operations, features, means, or instructions for receiving a common control message via both the first spatial layer and the second spatial layer, the common control message indicating that the resources allocated to the first spatial layer may be the same as resources allocated to the second spatial layer.

In some examples of the method, apparatuses, and non-transitory computer-readable medium described herein, receiving the indication may include operations, features, means, or instructions for receiving a common control message via each of the first spatial layer and the second spatial layer, the common control message indicating the set of resources of the second spatial layer being the same as a subset of the resources allocated to the first spatial layer.

In some examples of the method, apparatuses, and non-transitory computer-readable medium described herein, receiving the indication may include operations, features, means, or instructions for receiving a sidelink control message indicating that a part of the second spatial layer may be a repetition of a part of the first spatial layer, where the part of the second spatial layer may be associated with the set of resources.

In some examples of the method, apparatuses, and non-transitory computer-readable medium described herein, receiving the indication may include operations, features, means, or instructions for receiving a sidelink control message indicating that at least one subchannel of the second spatial layer corresponding to the set of resources includes a repetition of a subchannel of the first spatial layer, where the subchannel corresponds to the portion of the first data packet.

In some examples of the method, apparatuses, and non-transitory computer-readable medium described herein, receiving the indication may include operations, features, means, or instructions for receiving a sidelink control message indicating that a subchannel of the second spatial layer contains the mapped portion of the first data packet.

Some examples of the method, apparatuses, and non-transitory computer-readable medium described herein may further include operations, features, means, or instructions for receiving the first data packet via the first spatial layer in a transmission time interval, receiving the second data packet via the second spatial layer in the transmission time interval, and receiving the portion of the first data packet via the second spatial layer in the transmission time interval.

Some examples of the method, apparatuses, and non-transitory computer-readable medium described herein may further include operations, features, means, or instructions for receiving a sidelink control message indicating a boundary between the second data packet and the portion of the first data packet appended to the second data packet.

Some examples of the method, apparatuses, and non-transitory computer-readable medium described herein may further include operations, features, means, or instructions for receiving a message via the second spatial layer that includes the second data packet, the portion of the first data packet appended to the second data packet, and an error correction or detection code corresponding to the second data packet and the portion of the first data packet appended to the second data packet.

Some examples of the method, apparatuses, and non-transitory computer-readable medium described herein may further include operations, features, means, or instructions for receiving a message via the second spatial layer that includes the second data packet, a second error correction or detection code for the second data packet, the portion of the first data packet appended to the second data packet, and a first error correction or detection code for the portion of the first data packet appended to the second data packet.

Some examples of the method, apparatuses, and non-transitory computer-readable medium described herein may further include operations, features, means, or instructions for receiving an indication of a presence or absence of an error correction or detection code for the portion of the first data packet.

### BRIEF DESCRIPTION OF THE DRAWINGS

FIG. 1 illustrates an example of a wireless communications system that supports multi-transmission reception point (TRP) transmission schemes with partially overlapping resources in accordance with aspects of the present disclosure.

FIG. 2 illustrates an example of a wireless communications system that supports multi-TRP transmission schemes with partially overlapping resources in accordance with aspects of the present disclosure.

FIG. 3 illustrates an example of a physical layer mapping scheme that supports multi-TRP transmission schemes with partially overlapping resources in accordance with aspects of the present disclosure.

FIGS. 4A and 4B illustrate examples of a medium access control (MAC) layer mapping scheme that supports multi-TRP transmission schemes with partially overlapping resources in accordance with aspects of the present disclosure.

FIG. 5 illustrates an example of a process flow that supports multi-TRP transmission schemes with partially overlapping resources in accordance with aspects of the present disclosure.

FIGS. 6 and 7 show block diagrams of devices that support multi-TRP transmission schemes with partially overlapping resources in accordance with aspects of the present disclosure.

FIG. 8 shows a block diagram of a communications manager that supports multi-TRP transmission schemes with partially overlapping resources in accordance with aspects of the present disclosure.

FIG. 9 shows a diagram of a system including a device that supports multi-TRP transmission schemes with partially overlapping resources in accordance with aspects of the present disclosure.

FIGS. 10 through 12 show flowcharts illustrating methods that support multi-TRP transmission schemes with partially overlapping resources in accordance with aspects of the present disclosure.

### DETAILED DESCRIPTION

Some wireless communications systems may support sidelink communications. For example, a user equipment (UE) may communicate with one or more other UEs in a vehicle-to-vehicle (V2V) system, device-to-device communication (D2D) system, vehicle-to-everything (V2X) system, or internet of things (IoT) system, or the like. A UE may be an example of a vehicle, cellphone, laptop, or any other wireless device that supports operations including sidelink communications. In some examples, a UE may communicate with one or more other UEs using multiple TRPs (TRPs) of the UE. For instance, each TRP may transmit and receive signals from other UEs.

In some cases, the TRPs of a multi-TRP UE may be separated by some distance such that each TRP may view the channel used for communications differently. In one example, a small vehicle may include two TRPs separated by a distance of approximately three to four meters. The two TRPs may view the channel differently due to the physical location of each TRP with respect to other devices in the system. One TRP may have a non-line-of-sight (NLoS) with a UE, whereas another TRP may have line-of-sight (LoS) with the same UE. In some examples, a multi-TRP UE may be able to transmit directionally such that a first TRP may transmit a first packet in one direction and a second TRP may transmit a second packet in a second direction, which may lead to space-division multiplexing (SDM) gains.

In SDM, the same set of frequency resources may be used by two different TRPs that are geographically wide apart in space. In the case of a multi-TRP UE, the UE may SDM two or more packets associated with two or more TRPs for transmission simultaneously (e.g., in the same transmission time interval (TTI)) or at least partially overlapping in time, frequency, or both. In such examples, the UE may map a first data packet to a first spatial layer corresponding to a first TRP and a second data packet to a second spatial layer corresponding to a second TRP. In some examples, each spatial layer may include the same amount of frequency resources (e.g., subchannels or physical resource blocks (PRBs). For example, the first spatial layer and the second spatial layer may include a first subchannel, a second subchannel, and a third subchannel, where the subchannels of each layer fully or partially overlap in frequency. In some examples, the first data packet and the second data packet may be transmitted on a different amount of resources within their respective layers (due to packet size, modulation and coding scheme (MCS) for each spatial layer, etc.). For example, the first data packet may be transmitted over three subchannels and the second data packet may be transmitted over two subchannels. As such, one subchannel of the second layer may be unused. In some examples, a “null” message (e.g., a set of default bits such as a set of ‘0’ value bits) may be transmitted over the unused subchannel, which may indicate that the subchannel is invalid. However, a reference signal (e.g., a demodulation reference signal (DMRS)) may still be mapped across all of the subchannels of the second layer even if a null message is mapped to the unused subchannel. If the receiving device ignores the unused subchannel, the receiving device may refrain from decoding the reference signal mapped to the unused subchannel, which may lead to inaccurate channel estimations and may negatively impact the ability of the receiving device to decode the second data packet.

Aspects described herein may support enhanced techniques for sidelink multi-TRP SDM transmissions with partially overlapping resources. For example, a multi-TRP UE may transmit a first data packet and a second data packet over resources that at least partially overlap in time. In some examples, the first data packet and the second data packet may be mapped to different amounts of resources allocated to different spatial layers. For example, the first packet may be transmitted over three subchannels of a first layer and the second packet may be transmitted over two subchannels of a second spatial layer, where each layer includes three subchannels (e.g., a first subchannel, a second subchannel, and a third subchannel). The physical layer may map a portion of a first data packet (e.g., a transport block) of the first layer to an unused subchannel of the second layer. For example, the physical layer may map a portion of the first data packet transmitted on a third subchannel of the first layer to an unused subchannel of the second layer, where the unused channel may be the third subchannel of the second layer. Additionally or alternatively, the physical layer may map a subchannel with the highest interference (e.g., potential interference) of the first layer to an unused subchannel of the second layer. A receiving UE may utilize the portion of the first data packet mapped to the second layer to improve decoding success of the first data packet, to improve channel estimation, among others. For example, if the receiving UE is interested in only the second data packet, the receiving UE may disregard the added portion corresponding to the first data packet. Alternatively, if the UE is interested in both the first and second data packets, but only receives the second layer, the receiving UE may partially decode the first packet and transmit back to the multi-TRP UE a negative acknowledgement (NACK) for retransmission of the first data packet. If the receiving UE receives both layers, the receiving UE may decode both layers separately and combine the partial first data packet received on the second layer with first data packet received on the first layer for potential combining gains. By duplicating a portion of packet from one layer onto an unused channel of another layer, the multi-TRP UE may more efficiently utilize resources and may experience combining gains during SDM transmissions, which may increase the reliability of reception.

Aspects of the disclosure are initially described in the context of wireless communications systems. Additional aspects are described in the context of a physical layer mapping scheme, a medium access control (MAC) layer mapping scheme, and a process flow. Aspects of the disclosure are further illustrated by and described with reference to apparatus diagrams, system diagrams, and flowcharts that relate to multi-TRP transmission schemes with partially overlapping resources.

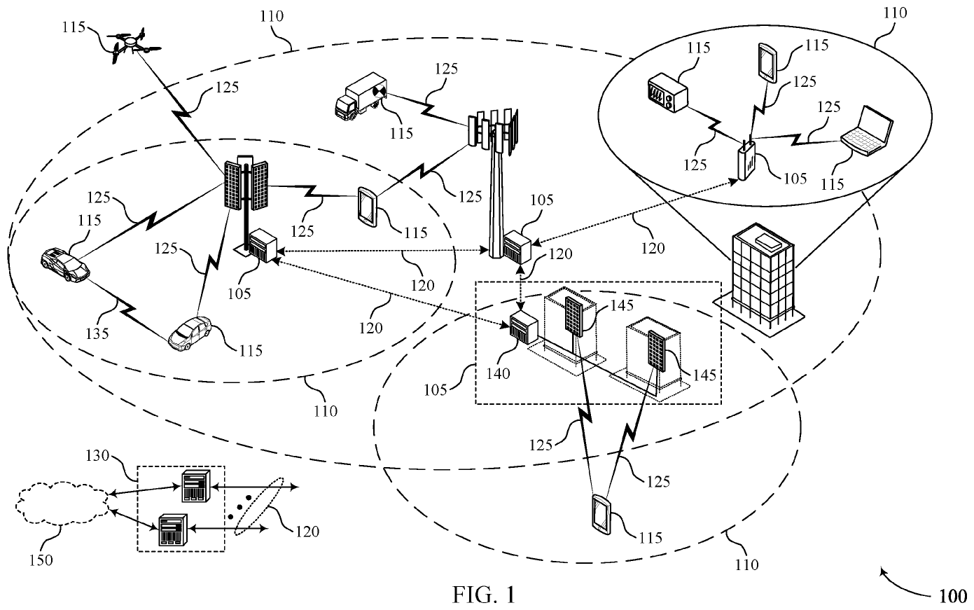

FIG. 1 illustrates an example of a wireless communications system 100 that supports multi-TRP transmission schemes with partially overlapping resources in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing or space-division multiplexing (SDM). The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In wireless communications system 100, the UE 115 may be an example of a multi-TRP UE. That is, the UE 115 may include multiple TRPs, which may be separated by some distance and may allow for simultaneous SDM transmissions, or SDM transmissions via two or more spatial layers that at least partially overlap in time. Each TRP of the multiple TRPs may include a separate radio frequency (RF) chain, but a common controller. In some examples, the UE 115 may determine to transmit two packets via two different TRPs in the same TTI. In some examples, a first packet may map to a larger number of frequency resources when compared to a second packet, which may result in unused frequency resources (e.g., PRBs or subchannels) in the layer to which the second packet is mapped. In such cases, the UE 115 may determine a portion of the first packet to transmit in the unused frequency resources of the spatial to which the second packet is mapped. That is, the UE may map the first packet to a first spatial layer associated with a first TRP and the UE 115 may map the second packet as well as the portion of the first packet to a second spatial layer associated with a second TRP. The UE 115 may utilize at least a portion of the unused frequency resource which may increase efficiency and decrease power consumption at the UE 115.

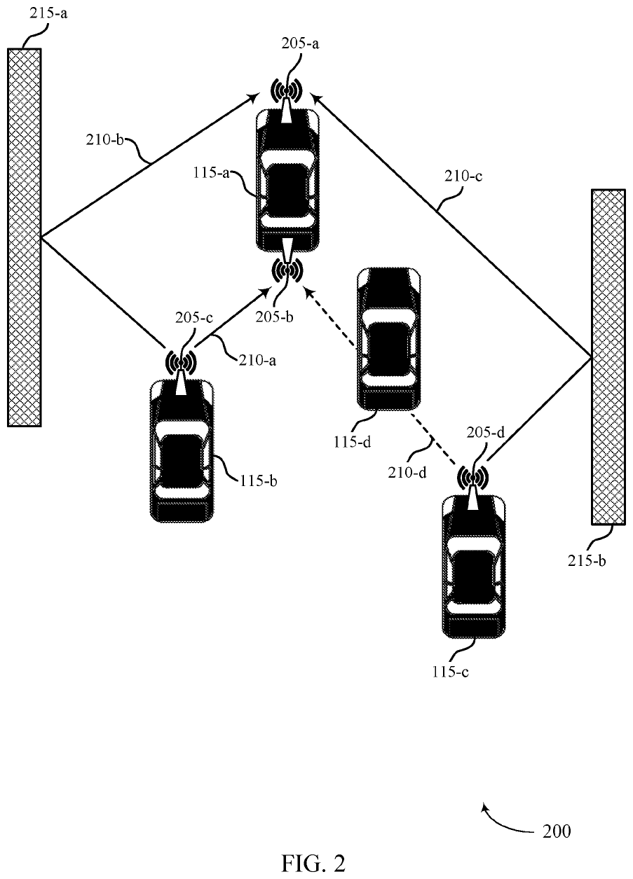

FIG. 2 illustrates an example of a wireless communications system 200 that supports multi-TRP transmission schemes with partially overlapping resources in accordance with aspects of the present disclosure. In some examples, the wireless communications system 200 may implement aspects of a wireless communications system 100. For example, the wireless communications system 200 may include UE 115-a, UE 115-b, UE 115-c, and UE 115-d, which may be examples of a UE 115 with reference to FIG. 1. UE 115-a, UE 115-b, UE 115-c, and UE 115-d may be examples of vehicle UEs (VUEs), roadside units (RSUs), laptops, cellphones, or any other type of wireless device.

The wireless communications system 200 may support sidelink communications. Examples of sidelink communication may be D2D communication, V2V communication, V2X communication and the like. In some examples, a UE may communicate with other UEs via sidelink communication using multiple transmission and reception points (TRPs). For example, UE 115-a may communicate with UE 115-b, UE 115-c, and UE 115-d via TRP 205-a and TRP 205-b. Alternatively, a UE may communicate with a single TRP. For example, UE 115-b may communicate via TRP 205-c and UE 115-c may communicate via TRP 205-d. TRP 205-a and TRP 205-b may utilize different radio frequency (RF) modules with a shared hardware and/or software controller and may be separated by some distance (e.g., a distance of three to four meters for cars and a distance of approximately twenty meters for trailers). In some examples, TRP 205-a may view a channel differently than TRP 205-b. This may due to the distance separating TRP 205-a and TRP 205-b. Distance between TRPs may cause a multi-TRP UE to receive signals from the same UE in different ways. For example, signal 210-a and signal 210-b may be transmitted from UE 115-b via TRP 205-c. Signal 210-a from UE 115-b to TRP 205-a may be classified as an NLoS signal and signal 210-b may be classified as an LoS signal. NLoS are transmissions across a path that is at least partially obstructed or reflected and LoS are transmissions across a path that has no or minimal obstruction. As such, signal 210-b may reflect off object 215-a to reach TRP 205-a, whereas signal 210-a may be capable of reaching TRP 205-b without reflection. In another example, both signal 210-c and signal 210-d may be classified as NLoS. However, unlike signal 210-c that has object 215-b to reflect off of to reach TRP 205-a, signal 210-d does not and thus, signal 210-c is obstructed by UE 115-d.

In some examples, UE 115-a may have the ability to receive and transmit directionally. That is, UE 115-a may transmit to one UE in a first direction using TRP 205-a and another UE in a second direction using TRP 205-b. Transmitting directionally may allow UE 115-a to transmit two or more data packets over TRP 205-a and TRP 205-b using the same or overlapping frequency resources in the same TTI in different directions which may lead to SDM gains. SDM may allow UE 115-a to transmit multiple signals via different spatial layers as describe the reference to FIG. 1. An example of transmissions that may be SDMed may be directional retransmissions of broadcast messages or data messages. For example, if TRP 205-a receives a negative acknowledgement (NACK) for a first packet from one direction and TRP 205-b receives a NACK for a second packet from another direction, UE 115-a may retransmit the first packet and the second packet via the respective TRPs 205 in different directions during the same TTI. Another example of transmissions that may be SDMed are directional transmissions indicated by the application layer (which may be based on directional requirements of the application generating a packet, network configuration, etc.).

In order to support simultaneous SDM transmissions via two or more TRPs, UE 115-a may signal an indication of the simultaneous transmission over a control channel (e.g., PSCCH) to a receiving UE 115. UE 115-a may determine a set of resources for joint transmission. If two or more packets are determined to be SDMed, the multi-TRP capable UE may map the two or more packet to two or more spatial layers, where each spatial layer corresponds to a respective TRP 205 used for transmission of that spatial layer. For example, UE 115-a may map a first packet to a first layer corresponding to TRP 205-a and map a second packet to a second layer corresponding to TRP 205-b. In some examples, the spatial layer for each TRP may include the same set of resources (e.g., subchannels or PRBs). For example, the first layer and the second layer may include the three subchannels. Alternatively, the first layer and the second layer may include partially overlapping sets of resources. In some examples, the first packet and the second packet may have a different number of allocated frequency resources. For example, the first packet may be transmitted over three subchannels of the first layer and the second packet may be transmitted over two subchannels of the second layer. In such case, the second spatial layer may include an unused subchannel. In some cases, UE 115-a may transmit “Null” signals over the unused subchannel of the second layer. “Null” signals may indicate that the unused subchannel is invalid. Transmission of a “Null” signal over the unused subchannel may result in inaccurate channel estimations as a reference signal (e.g., a DMRS) may be mapped across all of the resources allocated to the second spatial layer including the unused subchannel. As such, a UE 115 receiving the second packet (e.g., a UE 115-b, a UE 115-c, or a UE 115-d) may not receive (or may choose to drop) the DMRS that mapped to the unused subchannel and as a result may not properly decode the second packet. In addition, in order to maintain a constant power spectral density, UE 115-a may alter transmit power in the event of sending “Null” over the unused subchannel which may increase power consumption at UE 115-a. Moreover, in order to apply a pre-coding matrix to the multiple layers (e.g., the first and second layers), the symbols may used for transmission may be aligned.

Wireless communications system 200 may support sidelink multi-TRP SDM transmissions with partially or fully overlapping resources. For example, UE 115-a may determine to SDM a first packet and a second packet. In some examples, the first packet and the second packet may have a different amount of allocated frequency resources. For example, the first packet may be transmitted over three subchannels of the first layer and the second packet may be transmitted over two subchannels of the second layer, where each of the first layer and the second layer include a first subchannel, a second subchannel and a third subchannel. That is, one subchannel of the second layer may be considered unused. In some examples, UE 115-a may map part of a data packet of the first layer to the unused resources of the second layer. In one example, UE 115-a, at the physical layer, may map from the layer with a larger resource allocation to the layer with the smaller resource allocation. For example, UE 115-a may map at least a portion of the first packet to the unused subchannel of the second layer. The physical layer may determine which subchannel or PRBs to map the portion of the first packet to by using a direct one-to-one resource index mapping. For example, if the third subchannel (SC 3) of the second layer is the unused channel, the physical layer may map at least a portion of the first packet transmitted over the third subchannel (SC 3) of the first layer to the third subchannel of the second layer (e.g., unused channel). Additionally or alternatively, the physical layer may determine the mapping based on a level of interference seem by each subchannel of the first layer. For example, UE 115-a may determine, based on sensing information, that the second subchannel of the first layer has the highest interference when compared to the interference seen on the first subchannel and the second subchannel of the first layer and based on this, the physical layer may map at least a portion of the first packet transmitted on the second subchannel to the unused channel of the second layer. In some cases, the physical layer may refrain from mapping a portion of the first data packet transmitted over a subchannel including common control information.

In some examples, UE 115-a may transmit control signaling to indicate simultaneous SDM transmissions to one or more UEs. For example, UE 115-a may transmit control signaling indicating that the first layer and the second layer contain the same or partially overlapping resources via sidelink control information (SCI) (e.g., SCI-1). Additionally, UE 115-a may transmit control signaling indicating that part of second layer is a repetition of the first layer.

A receiving UE (e.g., UE 115-b, UE 115-c, and UE 115-d) may utilize the repeated portion of the first data packet on the second layer in a multitude of ways depending on the situation. In one example, the receiving UE may be interested in receiving the second packet over the second layer. In such example, the receiving UE 115 may discard the repeated portion of the first data packet. In another example, the receiving UE 115 may be interested in both the first data packet and the second data packet, but may only receive the second layer. In such example, the receiving UE 115 may fail to decode the first data packet on the second layer, transmit a NACK for the first packet to UE 115-a, and UE 115-a may determine to retransmit the first packet over the second layer. In yet another example, the receiving UE 115 may have the ability to receive both layers. In such example, the receiving UE may decode both layers and utilize the repeated portion of the first packet for potential combining gains. The aspects described herein may allow UE 115-a to utilize the unused subchannel which may result in efficient use of resources as well as reliability and decoding gains.

In some examples, the mapping between layers corresponding to different TRPs of a UE 1115 may take place at the MAC layer. UE 115-a, at the MAC layer, may determine that one or more subchannels may be unused based on the relative size of packets and/or the MCS associated with each packet. For example, the UE 115 may determine that a first packet on a first layer may utilize three subchannel and a second packet may utilize two subchannels. In such case, the MAC layer may append part of a transport block (TB) of the first packet of the first layer to a TB of the second packet of the second layer resulting in a combined TB. The length of the portion of TB of the first packet to be moved may be indicated in the MAC-CE header. In some examples, the cyclic redundancy check (CRC) at the end of the combined TB of the second layer may include a single common CRC. Alternatively, the combined TB of the second layer may include a common CRC as well as an error correction code (ECC) or error detection code (EDC) associated with the portion of the TB of the first packet and an ECC/EDC associated with the TB of the second packet. The packet-specific ECC/EDC may be indicated in the MAC-CE header.

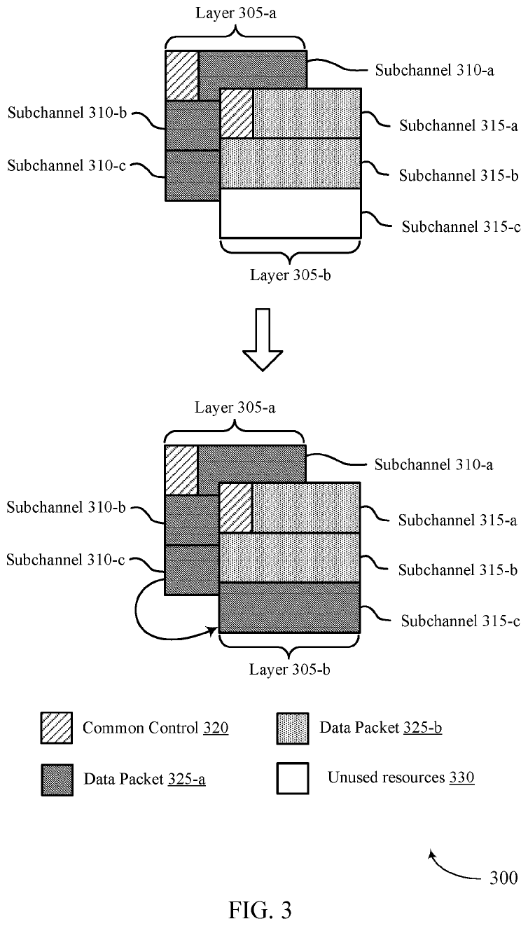

FIG. 3 illustrates an example of a physical layer mapping scheme 300 that supports multi-TRP transmission schemes with partially overlapping resources in accordance with aspects of the present disclosure. In some examples, the physical layer mapping scheme 300 may implement aspects of wireless communications systems 100 or 200. For example, the physical layer mapping scheme 300 may include a UE, which may be an example of a UE 115 with reference to FIGS. 1 and 2.

As described above, a UE may include two or more TRPs separated by some distance which may allow for simultaneous SDM transmissions or transmissions that at least partially overlap in time. That is, the UE may transmit two or more packets over individual TRPs in different directions simultaneously using the same or partially overlapping set of resources (e.g., PRBs or subchannels). For example, a UE may determine to utilize SDM in the transmission of data packet 325-a from a first TRP and data packet 325-b from a second TRP. In some examples, at the physical layer, the UE may map data packet 325-a to layer 305-a (e.g., a first spatial layer in an SDM scheme) and data packet 325-b to layer 305-b (e.g., a second spatial layer in an SDM scheme). Layer 305-a may include subchannel 310-a, subchannel 310-b, and subchannel 310-c and layer 305-b may include subchannel 315-a, subchannel 315-b, and subchannel 315-c. In some examples, layer 305-a and layer 305-b may include the same resources. That is, subchannels 310 may be equal to subchannels 315. Alternatively, layer 305-a and layer 305-b may include only some of the same resources. That is, one or more subchannels of subchannels 310 may overlap with one or more subchannels of subchannels 315. Each layer may also include common control 320. In some examples, data packet 325-a may allocate a different amount of frequency resources (e.g., subchannels or PRBs) when compared to data packet 325-b. For example, data packet 325-a may be transmitted over subchannel 310-a, subchannel 310-b, and subchannel 310-c, whereas data packet 325-b may be transmitted over subchannel 315-a and subchannel 315-b. In such example, subchannel 315-c may be considered unused or empty.

If the UE determines that the data packet 325-a and the data packet 325-b are allocated a different amount of frequency resources, the UE may map at least a portion of data packet 325-a to the unused resources 330 of layer 305-a. In one example, the mapping may be based on a one-to-one mapping between an index associated with unused resources 330 of layer 305-b and an index associated with a subchannel 310 of layer 305-b. For example, if the index of the unused resources 330 is three (e.g., SC 3) and the index of subchannel 310-c is also three then subchannel 310-c of layer 305-a may be mapped or duplicated to the unused resources 330. Subchannels of each layer 305 may be indexed based on their relative location in frequency (e.g., indexing may increase or decrease as frequency increases or decreases). Alternatively or additionally, the mapping may be based on interference experienced by subchannel 310-a, subchannel 310-b, and subchannel 310-c. For example, the UE may determine an interference level of each of subchannels 310 using channel sensing procedures and determine which portion of data packet 325-a corresponds to a subchannel 310 that has the highest interference, and may map that portion to the unused resources 330.

In some examples, a reference signal (e.g., DMRS) may be mapped to layer 305-a according to a first pattern or sequence across each subchannel 310 and the reference signal may be mapped to layer 305-b according to a second pattern across each subchannel 315. That is, the portion of data packet 325-a that is duplicated to unused resources 330 may be decoded at a receiving UE using the reference signal pattern or sequence for layer 305-b. In some examples, the UE may not map or duplicate a portion of the data packet 325-a transmitted on a subchannel 310 used to transmit the common control 320 to the layer 305-a. For example, the UE may determine not to duplicate a portion of the data packet 325-a transmitted on subchannel 310-a.

In some examples, the UE may transmit control signaling associated with simultaneous SDM transmissions via common control 320. The control signaling may include SCI (e.g., SCI-1 and SCI-2), where the SCI indicates that different resources or the same resources are allocated for layer 305-a and layer 305-b. Additionally, the SCI may indicate that a portion of layer 305-a is repeated on layer 305-b or that a repetition of the first data packet is mapped to layer 305-b.

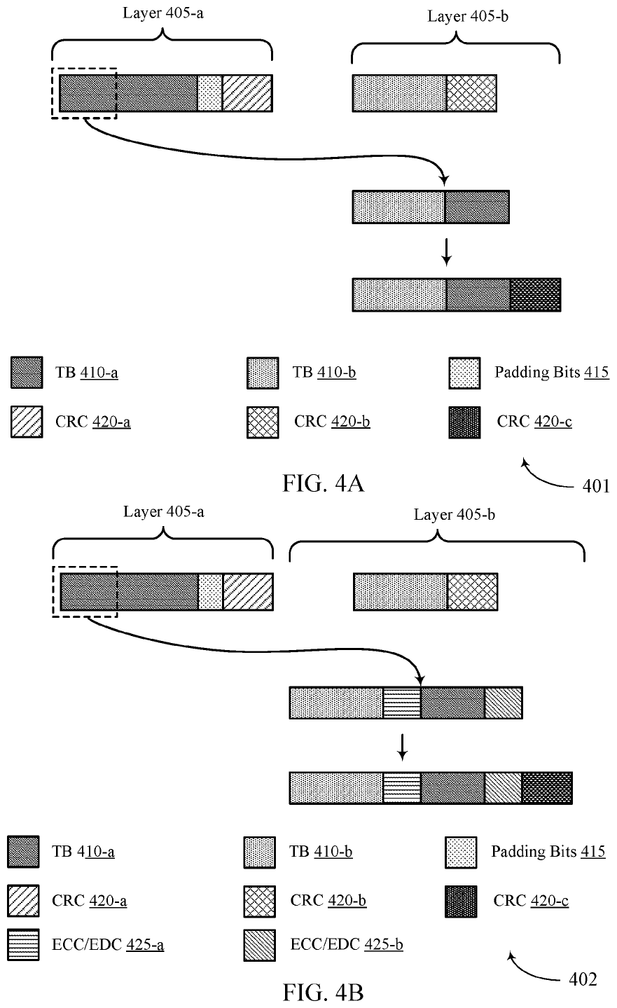

FIGS. 4A and 4B illustrate an example of a MAC layer mapping scheme 401 and a MAC layer mapping scheme 402 that supports multi-TRP transmission schemes with partially overlapping resources in accordance with aspects of the present disclosure. In some examples, the MAC layer mapping scheme 400 and the MAC layer mapping scheme 401 may implement aspects of a wireless communications system 100, a wireless communication system 200, and a physical layer mapping scheme 300. For example, the MAC layer mapping scheme 400 and the MAC layer mapping scheme 401 may include a UE which may be an example of a UE 115 with reference to FIGS. 1 through 3.

As described in FIG. 2, a UE may include two or more TRPs separated by some distance which may allow for simultaneous SDM transmissions. That is, the UE may transmit two or more packets over the individual TRPs in different directions simultaneously using the same or partially overlapping set of resources (e.g., PRBs or subchannels). For example, a UE may transmit a first packet mapped to layer 405-a and second packet mapped to layer 405-b. The UE may determine, at the MAC layer, that one or more subchannels of the of layer 405-a and layer 405-b may be unused by looking at the size of TB 410-a associated with the first packet and TB 410-b associated with the second packet and/or the modulation and coding scheme associated with each TB. For example, the UE may determine that TB 410-a will be transmitted over three subchannel and TB 410-b will be transmitted over two subchannels leaving an empty subchannel or unused subchannel on layer 405-b. Once the UE determines the empty or unused subchannel, the MAC layer may append a portion of TB 410-a from layer 405-a to TB 410-b of layer 405-b. In some examples, the length of the portion of TB 410-a to be duplicated may be indicated in the MAC-CE header. The MAC-CE header may be described as a set of data fields added at the beginning of a network packet in order to turn it into a frame to be transmitted and typically includes information such as the length of the network packet and the length or amount of padding bits 415. As such, data fields may be added to the MAC header to indicate the length of the portion of TB 410-a to be duplicated to layer 405-a.

In FIG. 4A, layer 405-a may include TB 410-a, padding bits 415, and CRC 420-a, where CRC 420 may be specific to TB 410-a. Originally, layer 405-b may include TB 410-b and CRC 420-b, where CRC 420-b may be specific to TB 410-a. As described above, the MAC layer may append a portion of TB 410-a and transfer it to TB 410-b of layer 405-b resulting in a combined TB. As a result, layer 405-b may include TB 410-b, the appended portion of TB 410-a, and a common CRC 420-c. Common CRC 420-c may be specific to the combined TB (e.g., TB 410-b, the duplicated portion of TB 410-a) and may be indicated in the MAC-CE header to a receiving UE.

In FIG. 4B, layer 405-a may include TB 410-a, padding bits 415, and CRC 420-a, where CRC 420 may be specific to TB 410-a. Originally, layer 405-b may include TB 410-b and CRC 420-b, where CRC 420-b may be specific to TB 410-a. As described above, the MAC layer may append a portion of TB 410-a and transfer it to TB 410-b of layer 405-b resulting in a combined TB. As a result, layer 405-b may include TB 410-b, the appended portion of TB 410-a, and a common CRC 420-c as well as ECC/EDC 425-a and ECC/EDC 425-c. Common CRC may be specific to the combined TB (e.g., TB 410-b, the duplicated portion of TB 410-a) and may be indicated in the MAC-CE header to a receiving UE. ECC/EDC 425-a may be associated with TB 410-b, whereas ECC/EDC 425-b may be associated with the portion of TB 410-a. Both ECC/EDC 425-a and ECC/EDC 425-b may be indicated via a MAC-CE header to the receiving UE.

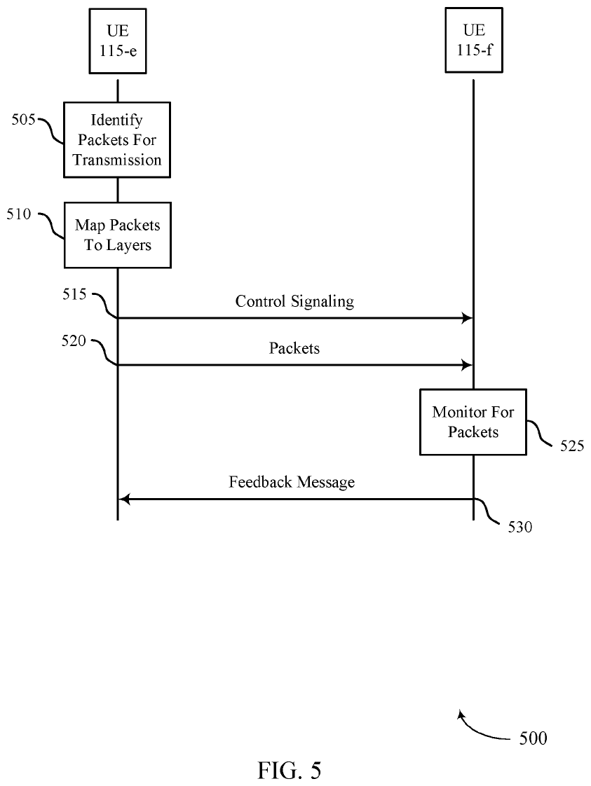

FIG. 5 illustrates an example of a process flow 500 that supports multi-TRP transmission schemes with partially overlapping resources in accordance with aspects of the present disclosure. In some examples, the process flow 500 may implement aspects of a wireless communications system 100, a wireless communications system 200, a physical layer mapping scheme 300, and a MAC layer mapping scheme 400. For example, the process flow may include UE 115-e and UE 115-f which may be examples of a UE 115 as described with reference to FIGS. 2-4. As described with reference to FIGS. 2 through 4, a UE 115 may be an example of a multi-TRP UE. The UE may determine that frequency resources of a spatial layer are unused and may duplicate or map a portion of a data packet from a different spatial layer to the unused resources at the MAC level or the physical level. UE 115 may transmit the portion of the data packet to another UE 115 over the spatial layer and the receiving UE may determine to ignore the portion of the data packets or utilize the portion of the data packet for combining purposes. Alternative examples of the following may be implemented, where some steps are performed in a different order than described or are not performed at all. In some cases, steps may include additional features not mentioned below, or further steps may be added.

At 505, UE 115-e may identify two or more packets for transmission via two or more transmission points. For example, UE 115-e may identify a first packets to be transmitted by a first TRP over a first spatial layer and a second packet to be transmitted by a second TRP over a second spatial layer. In some examples, the first spatial layer and the second spatial layer may allocate the same set of resources. Alternatively, the first spatial layer and the second spatial layer may allocate sets of partially overlapping resources.

At 510, UE 115-e may map data packets to the different layers. If the resources allocated for transmission of the second packet span less frequency resources than available on the second spatial layer (e.g., two out of three available subchannels), UE 115-e may map a portion of the first packet to an unused subchannel of second spatial layer. At the physical layer, UE 115-e may determine which portion of the first packet to duplicate or map to the second spatial layer based the subchannel index of the unused subchannel. For example, if the unused subchannel index is three then UE 115-e may map a portion of the first packet transmitted over a subchannel associated with an index of three of the first spatial layer to the unused subchannel. Alternatively, at the physical layer, UE 115-e may determine which portion of the first packet to duplicate or map to the unused channel based on the amount of potential interference seen at each subchannel of the first spatial layer. UE 115-e may determine a subchannel with the highest amount of potential interference and map the portion of the first packet to be transmitted over the subchannel with the highest amount of potential interference to the unused subchannel of the second spatial layer.

At the MAC layer, the UE may determine one or more subchannel may be unused based on the relative size of the first packet and the second packet and based on the modulation scheme associated with the first packet and the second packet. In the event that the size of the second packet is smaller than the first packet, UE 115-e may append a part of the TB of the first packet to the TB of the second packet creating a combined TB. The packet boundaries (e.g., the length of the appended transport block of the first packet) may be indicated as part of the MAC header. In some examples, the combined transport block may include a common CRC. That is, the CRC may apply to both the TB of the second packet and the appended part of the TB of the first packet. In some examples, the combined TB includes a common CRC as well as the separate ECC and/or EDC for the TB of the second packet and the appended part of the TB of the first packet. The indication of presence of the common CRC and/or the presence of the separate EDC and/or EDC may be indicated to a receiving UE (e.g., UE 115-f) via a MAC-CE header.

At 515, UE 115-e may control signaling to UE 115-f via the common control included on each of the spatial layers. In some examples, the control signaling may include an indication of the set of resources allocated to the two or more spatial layers (e.g., the first spatial layer and the second spatial layer). The set of resources indicated by the control signaling may be the same or different for each spatial layer and may be signaled via SCI-1. The control signaling may also include an indication that a part of one layer is repeated on another layer (e.g., a portion of the first packet is mapped to the second layer) and the type of control signal may be SCI-2. The set of resources of each spatial layer may be indexed such as to convey the above indications. For example, SCI-1 may signal SC [1,3] to indicate that the first spatial layer the second spatial layer includes subchannels one through 3. In another example, SC1-2 may signal Layer 2 SC [3] to indicate that a portion of the first packet is transmitted over subchannel three of the second spatial layer.

At 520, UE 115-e may transmit one or more packets to UE 115-f via one or more TRPs. For example, UE 115-e may transmit a first packet via the first TRP and/or the second packet and a portion of the first packet via the second TRP.

At 525, UE 115-f may monitor for two or more packets. In some examples, UE 115-f may monitor a set of resources associated with the second spatial layer for the second packet and the portion of the first packet. In some examples, UE 115-f may also monitor a set of resources associated with the first spatial layer for the first packet. If UE 115-f is interested in the second packet, UE 115-f ignore the portion of the first packet and decode the second packet. If UE 115-f is interested in both packets, the UE may either receive one or both of the spatial layers. If UE 115-f receives both spatial layers, UE 115-f may combine the portion of the first data packet on the second spatial layer with the first packet on the first spatial layer. If UE 115-f receives the second spatial layer, UE 115-f may decode the portion of the first data packets and transmit a NACK feedback message to UE 115-e at 530. UE 115-e may determine to retransmit the first data packet via the second TRP to UE 115-f based on the feedback message.

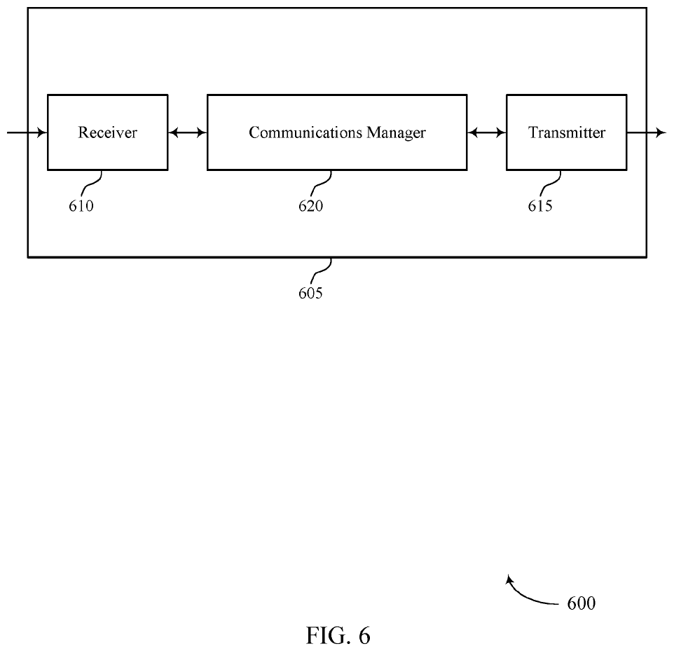

FIG. 6 shows a block diagram 600 of a device 605 that supports multi-TRP transmission schemes with partially overlapping resources in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to multi-TRP transmission schemes with partially overlapping resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multi-TRP transmission schemes with partially overlapping resources). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of multi-TRP transmission schemes with partially overlapping resources as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for identifying a first data packet for transmission using a first spatial layer and a second data packet for transmission using a second spatial layer, the first spatial layer associated with a first TRP of the UE and the second spatial layer associated with a second TRP of the UE. The communications manager 620 may be configured as or otherwise support a means for mapping a portion of the first data packet to a set of resources of the second spatial layer, the set of resources at least partially overlapping in time with resources allocated to the first spatial layer. The communications manager 620 may be configured as or otherwise support a means for transmitting a control message indicating that the portion of the first data packet is mapped to the second spatial layer.

Additionally or alternatively, the communications manager 620 may support wireless communications at a first UE in accordance with examples as disclosed herein. For example, the communications manager 620 may be configured as or otherwise support a means for receiving, from a second UE, an indication that a portion of a first data packet for transmission to the first UE is mapped to a second spatial layer, the first spatial layer associated with a first TRP of the second UE and the second spatial layer associated with a second TRP of the second UE. The communications manager 620 may be configured as or otherwise support a means for monitoring a set of resources of the second spatial layer for the portion of the first data packet, a second data packet, or both, where the set of resources at least partially overlaps resources allocated to the first spatial layer in time. The communications manager 620 may be configured as or otherwise support a means for transmitting a feedback message for the portion of the first data packet or the second data packet based on monitoring the set of resources.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced power consumption at device 605 as well as increased reliability and efficiency. By utilizing unused resources of a spatial layer, the device 605 may avoid altering (e.g., increasing) transmission power, and may increase throughput and network efficiency. In addition, in the event that device 605 receives a packet on a first spatial layer and a portion of the packet on a second spatial layer, device 605 may see potential combining gains.

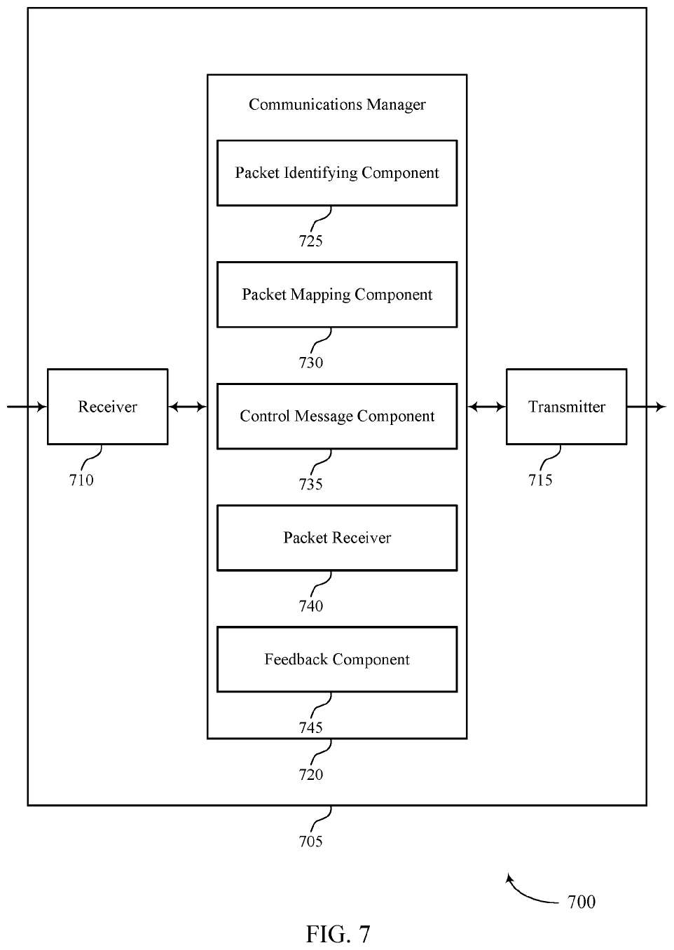

FIG. 7 shows a block diagram 700 of a device 705 that supports multi-TRP transmission schemes with partially overlapping resources in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-TRP transmission schemes with partially overlapping resources). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-TRP transmission schemes with partially overlapping resources). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multi-TRP transmission schemes with partially overlapping resources as described herein. For example, the communications manager 720 may include a packet identifying component 725, a packet mapping component 730, a control message component 735, a packet receiver 740, a feedback component 745, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The packet identifying component 725 may be configured as or otherwise support a means for identifying a first data packet for transmission using a first spatial layer and a second data packet for transmission using a second spatial layer, the first spatial layer associated with a first TRP of the UE and the second spatial layer associated with a second TRP of the UE. The packet mapping component 730 may be configured as or otherwise support a means for mapping a portion of the first data packet to a set of resources of the second spatial layer, the set of resources at least partially overlapping in time with resources allocated to the first spatial layer. The control message component 735 may be configured as or otherwise support a means for transmitting a control message indicating that the portion of the first data packet is mapped to the second spatial layer.

Additionally or alternatively, the communications manager 720 may support wireless communications at a first UE in accordance with examples as disclosed herein. The control message component 735 may be configured as or otherwise support a means for receiving, from a second UE, an indication that a portion of a first data packet for transmission to the first UE is mapped to a second spatial layer, the first spatial layer associated with a first TRP of the second UE and the second spatial layer associated with a second TRP of the second UE. The packet receiver 740 may be configured as or otherwise support a means for monitoring a set of resources of the second spatial layer for the portion of the first data packet, a second data packet, or both, where the set of resources at least partially overlaps resources allocated to the first spatial layer in time. The feedback component 745 may be configured as or otherwise support a means for transmitting a feedback message for the portion of the first data packet or the second data packet based on monitoring the set of resources.

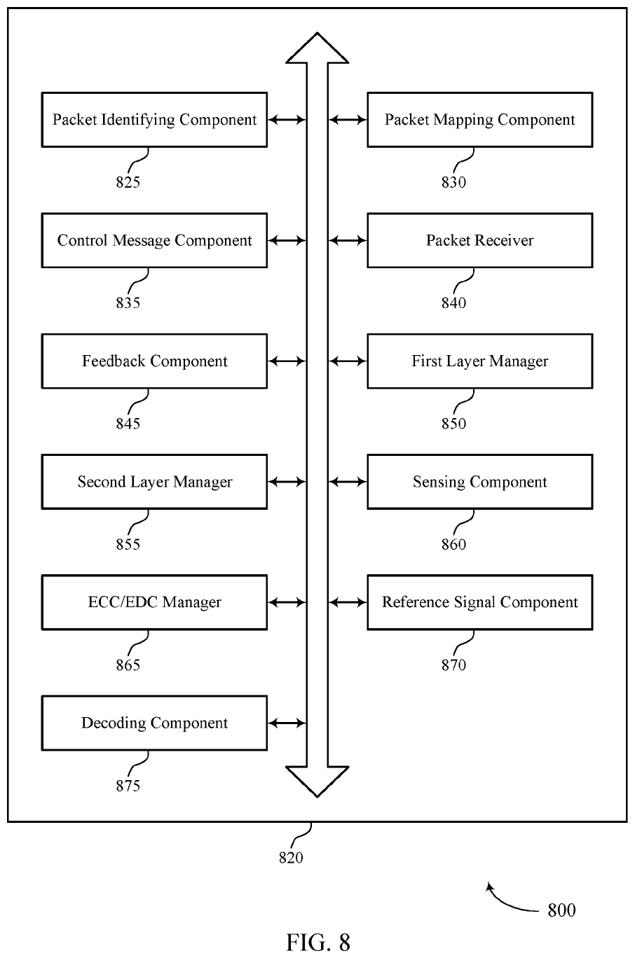

FIG. 8 shows a block diagram 800 of a communications manager 820 that supports multi-TRP transmission schemes with partially overlapping resources in accordance with aspects of the present disclosure. The communications manager 820 may be an example of aspects of a communications manager 620, a communications manager 720, or both, as described herein. The communications manager 820, or various components thereof, may be an example of means for performing various aspects of multi-TRP transmission schemes with partially overlapping resources as described herein. For example, the communications manager 820 may include a packet identifying component 825, a packet mapping component 830, a control message component 835, a packet receiver 840, a feedback component 845, a first layer manager 850, a second layer manager 855, a sensing component 860, a ECC/EDC manager 865, a reference signal component 870, a decoding component 875, or any combination thereof. Each of these components may communicate, directly or indirectly, with one another (e.g., via one or more buses).

The communications manager 820 may support wireless communications at a UE in accordance with examples as disclosed herein. The packet identifying component 825 may be configured as or otherwise support a means for identifying a first data packet for transmission using a first spatial layer and a second data packet for transmission using a second spatial layer, the first spatial layer associated with a first TRP of the UE and the second spatial layer associated with a second TRP of the UE. The packet mapping component 830 may be configured as or otherwise support a means for mapping a portion of the first data packet to a set of resources of the second spatial layer, the set of resources at least partially overlapping in time with resources allocated to the first spatial layer. The control message component 835 may be configured as or otherwise support a means for transmitting a control message indicating that the portion of the first data packet is mapped to the second spatial layer.

In some examples, to support transmitting the control message, the control message component 835 may be configured as or otherwise support a means for transmitting a common control message via both the first spatial layer and the second spatial layer, the common control message indicating that the resources allocated to the first spatial layer are the same as resources allocated to the second spatial layer.

In some examples, to support transmitting the control message, the control message component 835 may be configured as or otherwise support a means for transmitting a common control message via each of the first spatial layer and the second spatial layer, the common control message indicating the set of resources of the second spatial layer being the same as a subset of the resources allocated to the first spatial layer.

In some examples, to support transmitting the control message, the control message component 835 may be configured as or otherwise support a means for transmitting a sidelink control message indicating that a part of the second spatial layer is a repetition of a part of the first spatial layer, where the part of the second spatial layer is associated with the set of resources.

In some examples, to support transmitting the control message, the control message component 835 may be configured as or otherwise support a means for transmitting a sidelink control message indicating that at least one subchannel of the second spatial layer corresponding to the set of resources includes a repetition of a subchannel of the first spatial layer, where the subchannel corresponds to the portion of the first data packet.

In some examples, to support transmitting the control message, the control message component 835 may be configured as or otherwise support a means for transmitting a sidelink control message indicating that a subchannel of the second spatial layer contains the mapped portion of the first data packet.

In some examples, the first layer manager 850 may be configured as or otherwise support a means for transmitting the first data packet via the first spatial layer in a transmission time interval. In some examples, the second layer manager 855 may be configured as or otherwise support a means for transmitting the second data packet via the second spatial layer in the transmission time interval. In some examples, the second layer manager 855 may be configured as or otherwise support a means for transmitting the portion of the first data packet via the second spatial layer in the transmission time interval.

In some examples, the sensing component 860 may be configured as or otherwise support a means for performing a channel sensing procedure on the first spatial layer. In some examples, the packet mapping component 830 may be configured as or otherwise support a means for determining the portion of the first data packet for mapping to the second spatial layer based on the channel sensing procedure.

In some examples, the portion of the first data packet determined for mapping to the second spatial layer corresponds to a subchannel of the first spatial layer associated with a highest interference measurement based on the channel sensing procedure.

In some examples, the packet mapping component 830 may be configured as or otherwise support a means for determining the portion of the first data packet for mapping, where the first portion of the data packet corresponds to a first subchannel of the first spatial layer different from a second subchannel of the first spatial layer that is allocated for transmission of the control message.

In some examples, the packet mapping component 830 may be configured as or otherwise support a means for appending the portion of the first data packet to the second data packet before transmission of the first and second data packets.

In some examples, to support transmitting the control message, the control message component 835 may be configured as or otherwise support a means for transmitting a sidelink control message indicating a boundary between the second data packet and the portion of the first data packet based on the appending.

In some examples, the boundary is indicated via a medium access control (MAC) control element (MAC-CE).

In some examples, the ECC/EDC manager 865 may be configured as or otherwise support a means for generating an error correction or detection code of the second data packet and the appended portion of the first data packet. In some examples, the second layer manager 855 may be configured as or otherwise support a means for transmitting a message via the second spatial layer that includes the second data packet, the appended portion of the first data packet, and the error correction or detection code.

In some examples, the ECC/EDC manager 865 may be configured as or otherwise support a means for generating a first error correction or detection code for the portion of the first data packet. In some examples, the ECC/EDC manager 865 may be configured as or otherwise support a means for generating a second error correction or detection code for the second data packet. In some examples, the packet mapping component 830 may be configured as or otherwise support a means for appending the portion of the first data packet and the first error correction or detection code to the second data packet and the second error correction or detection code. In some examples, the second layer manager 855 may be configured as or otherwise support a means for transmitting a message via the second spatial layer that includes the second data packet, the second error correction or detection code, the appended portion of the first data packet, and the appended first error correction or detection code.

In some examples, the ECC/EDC manager 865 may be configured as or otherwise support a means for generating a combined error correction or detection code for a combination of the second data packet, the second error correction or detection code, the appended portion of the first data packet, and the appended first error correction or detection code, where the message includes the combined error correction or detection code.

In some examples, the ECC/EDC manager 865 may be configured as or otherwise support a means for transmitting an indication of a presence or absence of an error correction or detection code for the portion of the first data packet.

In some examples, the reference signal component 870 may be configured as or otherwise support a means for mapping a set of reference signal symbols across all resources allocated to the first spatial layer and all resources allocated to the second spatial layer.

In some examples, the reference signal component 870 may be configured as or otherwise support a means for mapping a first reference signal to a subset of the resources allocated to the first spatial layer according to a first reference signal pattern for the first spatial layer. In some examples, the reference signal component 870 may be configured as or otherwise support a means for mapping a second reference signal to resources allocated to the second spatial layer including the set of resources according to a second reference signal pattern for the second spatial layer.

In some examples, the packet mapping component 830 may be configured as or otherwise support a means for determining a first packet size of the first data packet for transmission using the first spatial layer based on a first modulation and coding scheme associated with the first data packet. In some examples, the packet mapping component 830 may be configured as or otherwise support a means for determining a second packet size of the second data packet for transmission using the second spatial layer based on a second modulation and coding scheme associated with the second data packet. In some examples, the packet mapping component 830 may be configured as or otherwise support a means for determining to map the portion of the first data packet to the second spatial layer based on the first packet size being greater than the second packet size.

In some examples, the packet mapping component 830 may be configured as or otherwise support a means for determining a first number of subchannels for transmission of the first data packet using the first spatial layer. In some examples, the packet mapping component 830 may be configured as or otherwise support a means for determining a second number of subchannels for transmission of the second data packet using the second spatial layer. In some examples, the packet mapping component 830 may be configured as or otherwise support a means for determining to map the portion of the first data packet to the second spatial layer based on the first number of subchannels being greater than the second number of subchannels.

Additionally or alternatively, the communications manager 820 may support wireless communications at a first UE in accordance with examples as disclosed herein. In some examples, the control message component 835 may be configured as or otherwise support a means for receiving, from a second UE, an indication that a portion of a first data packet for transmission to the first UE is mapped to a second spatial layer, the first spatial layer associated with a first TRP of the second UE and the second spatial layer associated with a second TRP of the second UE. The packet receiver 840 may be configured as or otherwise support a means for monitoring a set of resources of the second spatial layer for the portion of the first data packet, a second data packet, or both, where the set of resources at least partially overlaps resources allocated to the first spatial layer in time. The feedback component 845 may be configured as or otherwise support a means for transmitting a feedback message for the portion of the first data packet or the second data packet based on monitoring the set of resources.

In some examples, to support transmitting the feedback message, the feedback component 845 may be configured as or otherwise support a means for transmitting a negative acknowledgement message based on an unsuccessful decoding of the first layer.

In some examples, the packet receiver 840 may be configured as or otherwise support a means for storing the portion of the first data packet received using the second spatial layer. In some examples, the packet receiver 840 may be configured as or otherwise support a means for receiving a retransmission of the first data packet via the second TRP of the second UE.

In some examples, the first layer manager 850 may be configured as or otherwise support a means for receiving the first data packet using the first spatial layer. In some examples, the decoding component 875 may be configured as or otherwise support a means for combining, as part of a decoding procedure of the first data packet, the first data packet with the portion of the first data packet received using the second spatial layer.

In some examples, the decoding component 875 may be configured as or otherwise support a means for dropping the portion of the first data packet via the set of resources of the second spatial layer, where the feedback message is transmitted based on a result of a decoding procedure of the second data packet received using the second spatial layer.

In some examples, to support receiving the indication, the control message component 835 may be configured as or otherwise support a means for receiving a common control message via both the first spatial layer and the second spatial layer, the common control message indicating that the resources allocated to the first spatial layer are the same as resources allocated to the second spatial layer.

In some examples, to support receiving the indication, the control message component 835 may be configured as or otherwise support a means for receiving a common control message via each of the first spatial layer and the second spatial layer, the common control message indicating the set of resources of the second spatial layer being the same as a subset of the resources allocated to the first spatial layer.

In some examples, to support receiving the indication, the control message component 835 may be configured as or otherwise support a means for receiving a sidelink control message indicating that a part of the second spatial layer is a repetition of a part of the first spatial layer, where the part of the second spatial layer is associated with the set of resources.

In some examples, to support receiving the indication, the control message component 835 may be configured as or otherwise support a means for receiving a sidelink control message indicating that at least one subchannel of the second spatial layer corresponding to the set of resources includes a repetition of a subchannel of the first spatial layer, where the subchannel corresponds to the portion of the first data packet.

In some examples, to support receiving the indication, the control message component 835 may be configured as or otherwise support a means for receiving a sidelink control message indicating that a subchannel of the second spatial layer contains the mapped portion of the first data packet.

In some examples, the first layer manager 850 may be configured as or otherwise support a means for receiving the first data packet via the first spatial layer in a transmission time interval. In some examples, the second layer manager 855 may be configured as or otherwise support a means for receiving the second data packet via the second spatial layer in the transmission time interval. In some examples, the second layer manager 855 may be configured as or otherwise support a means for receiving the portion of the first data packet via the second spatial layer in the transmission time interval.

In some examples, the control message component 835 may be configured as or otherwise support a means for receiving a sidelink control message indicating a boundary between the second data packet and the portion of the first data packet appended to the second data packet.

In some examples, the second layer manager 855 may be configured as or otherwise support a means for receiving a message via the second spatial layer that includes the second data packet, the portion of the first data packet appended to the second data packet, and an error correction or detection code corresponding to the second data packet and the portion of the first data packet appended to the second data packet.

In some examples, the ECC/EDC manager 865 may be configured as or otherwise support a means for receiving a message via the second spatial layer that includes the second data packet, a second error correction or detection code for the second data packet, the portion of the first data packet appended to the second data packet, and a first error correction or detection code for the portion of the first data packet appended to the second data packet.

In some examples, the ECC/EDC manager 865 may be configured as or otherwise support a means for receiving an indication of a presence or absence of an error correction or detection code for the portion of the first data packet.

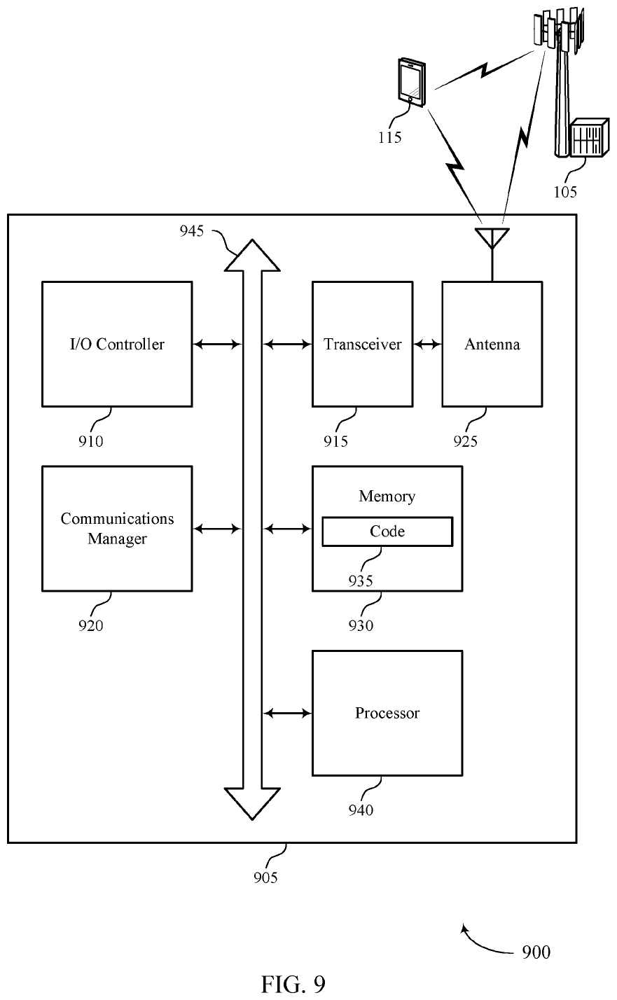

FIG. 9 shows a diagram of a system 900 including a device 905 that supports multi-TRP transmission schemes with partially overlapping resources in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting multi-TRP transmission schemes with partially overlapping resources). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for identifying a first data packet for transmission using a first spatial layer and a second data packet for transmission using a second spatial layer, the first spatial layer associated with a first TRP of the UE and the second spatial layer associated with a second TRP of the UE. The communications manager 920 may be configured as or otherwise support a means for mapping a portion of the first data packet to a set of resources of the second spatial layer, the set of resources at least partially overlapping in time with resources allocated to the first spatial layer. The communications manager 920 may be configured as or otherwise support a means for transmitting a control message indicating that the portion of the first data packet is mapped to the second spatial layer.

Additionally or alternatively, the communications manager 920 may support wireless communications at a first UE in accordance with examples as disclosed herein. For example, the communications manager 920 may be configured as or otherwise support a means for receiving, from a second UE, an indication that a portion of a first data packet for transmission to the first UE is mapped to a second spatial layer, the first spatial layer associated with a first TRP of the second UE and the second spatial layer associated with a second TRP of the second UE. The communications manager 920 may be configured as or otherwise support a means for monitoring a set of resources of the second spatial layer for the portion of the first data packet, a second data packet, or both, where the set of resources at least partially overlaps resources allocated to the first spatial layer in time. The communications manager 920 may be configured as or otherwise support a means for transmitting a feedback message for the portion of the first data packet or the second data packet based on monitoring the set of resources.

By including or configuring the communications manager 920 in accordance with examples as described herein, the device 905 may support techniques for device 605 to improve reliability in term of packet decoding and processing.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of multi-TRP transmission schemes with partially overlapping resources as described herein, or the processor 940 and the memory 930 may be otherwise configured to perform or support such operations.

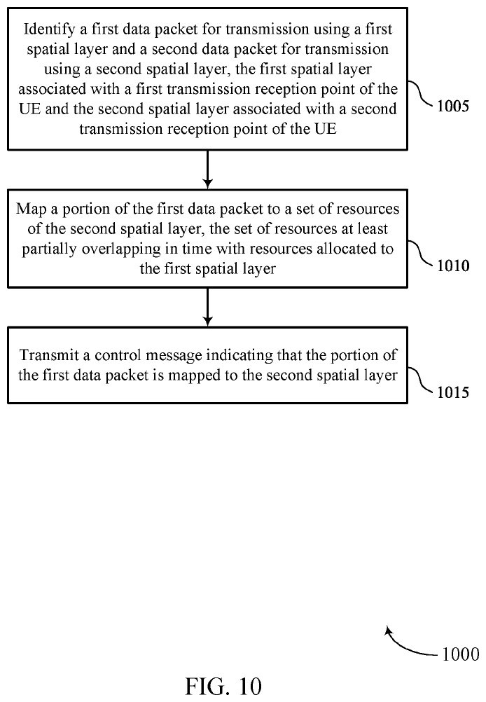

FIG. 10 shows a flowchart illustrating a method 1000 that supports multi-TRP transmission schemes with partially overlapping resources in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include identifying a first data packet for transmission using a first spatial layer and a second data packet for transmission using a second spatial layer, the first spatial layer associated with a first TRP of the UE and the second spatial layer associated with a second TRP of the UE. The operations of 1005 may be performed in accordance with examples as disclosed herein. In some examples, aspects of the operations of 1005 may be performed by a packet identifying component 825 as described with reference to FIG. 8.

At 1010, the method may include mapping a portion of the first data packet to a set of resources of the second spatial layer, the set of resources at least partially overlapping in time with resources allocated to the first spatial layer. The operations of 1010 may be performed in accordance with examples as disclosed herein. In some examples, aspects of the operations of 1010 may be performed by a packet mapping component 830 as described with reference to FIG. 8.

At 1015, the method may include transmitting a control message indicating that the portion of the first data packet is mapped to the second spatial layer. The operations of 1015 may be performed in accordance with examples as disclosed herein. In some examples, aspects of the operations of 1015 may be performed by a control message component 835 as described with reference to FIG. 8.

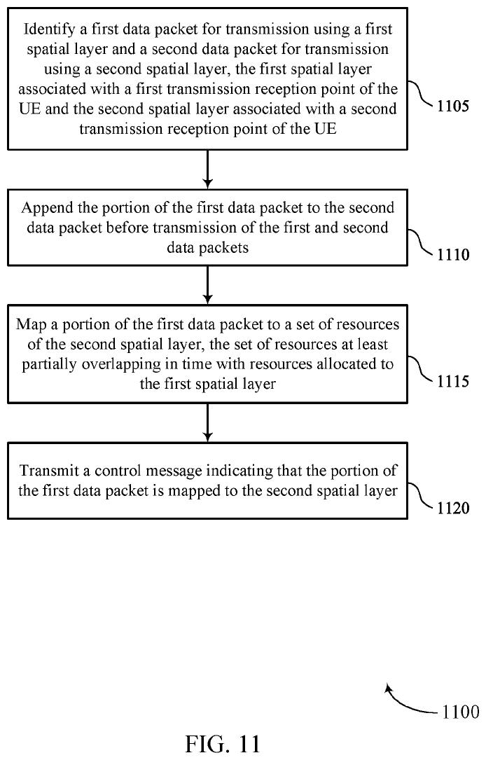

FIG. 11 shows a flowchart illustrating a method 1100 that supports multi-TRP transmission schemes with partially overlapping resources in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include identifying a first data packet for transmission using a first spatial layer and a second data packet for transmission using a second spatial layer, the first spatial layer associated with a first TRP of the UE and the second spatial layer associated with a second TRP of the UE. The operations of 1105 may be performed in accordance with examples as disclosed herein. In some examples, aspects of the operations of 1105 may be performed by a packet identifying component 825 as described with reference to FIG. 8.

At 1110, the method may include appending the portion of the first data packet to the second data packet before transmission of the first and second data packets. The operations of 1110 may be performed in accordance with examples as disclosed herein. In some examples, aspects of the operations of 1110 may be performed by a packet mapping component 830 as described with reference to FIG. 8.

At 1115, the method may include mapping a portion of the first data packet to a set of resources of the second spatial layer, the set of resources at least partially overlapping in time with resources allocated to the first spatial layer. The operations of 1115 may be performed in accordance with examples as disclosed herein. In some examples, aspects of the operations of 1115 may be performed by a packet mapping component 830 as described with reference to FIG. 8.

At 1120, the method may include transmitting a control message indicating that the portion of the first data packet is mapped to the second spatial layer. The operations of 1120 may be performed in accordance with examples as disclosed herein. In some examples, aspects of the operations of 1120 may be performed by a control message component 835 as described with reference to FIG. 8.

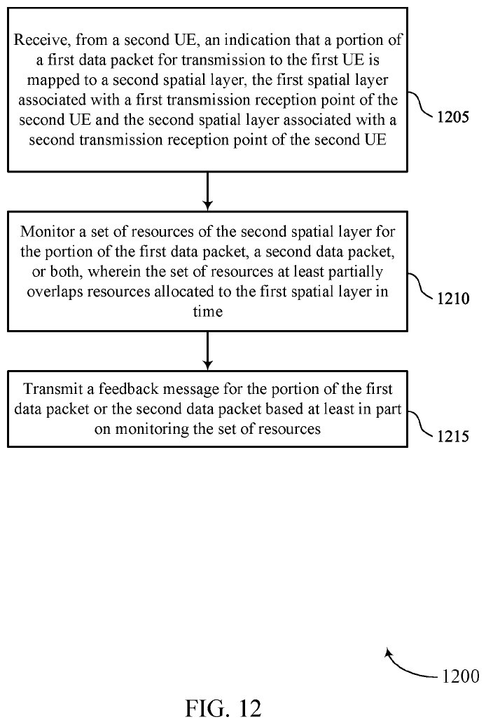

FIG. 12 shows a flowchart illustrating a method 1200 that supports multi-TRP transmission schemes with partially overlapping resources in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving, from a second UE, an indication that a portion of a first data packet for transmission to the first UE is mapped to a second spatial layer, the first spatial layer associated with a first TRP of the second UE and the second spatial layer associated with a second TRP of the second UE. The operations of 1205 may be performed in accordance with examples as disclosed herein. In some examples, aspects of the operations of 1205 may be performed by a control message component 835 as described with reference to FIG. 8.

At 1210, the method may include monitoring a set of resources of the second spatial layer for the portion of the first data packet, a second data packet, or both, where the set of resources at least partially overlaps resources allocated to the first spatial layer in time. The operations of 1210 may be performed in accordance with examples as disclosed herein. In some examples, aspects of the operations of 1210 may be performed by a packet receiver 840 as described with reference to FIG. 8.

At 1215, the method may include transmitting a feedback message for the portion of the first data packet or the second data packet based on monitoring the set of resources. The operations of 1215 may be performed in accordance with examples as disclosed herein. In some examples, aspects of the operations of 1215 may be performed by a feedback component 845 as described with reference to FIG. 8.

The following provides an overview of aspects of the present disclosure:

Aspect 1: A method for wireless communications at a UE, comprising: identifying a first data packet for transmission using a first spatial layer and a second data packet for transmission using a second spatial layer, the first spatial layer associated with a first transmission reception point of the UE and the second spatial layer associated with a second transmission reception point of the UE; mapping a portion of the first data packet to a set of resources of the second spatial layer, the set of resources at least partially overlapping in time with resources allocated to the first spatial layer; and transmitting a control message indicating that the portion of the first data packet is mapped to the second spatial layer.

Aspect 2: The method of aspect 1, wherein transmitting the control message comprises: transmitting a common control message via both the first spatial layer and the second spatial layer, the common control message indicating that the resources allocated to the first spatial layer are the same as resources allocated to the second spatial layer.

Aspect 3: The method of any of aspects 1 through 2, wherein transmitting the control message comprises: transmitting a common control message via each of the first spatial layer and the second spatial layer, the common control message indicating the set of resources of the second spatial layer being the same as a subset of the resources allocated to the first spatial layer.

Aspect 4: The method of any of aspects 1 through 3, wherein transmitting the control message comprises: transmitting a sidelink control message indicating that a part of the second spatial layer is a repetition of a part of the first spatial layer, wherein the part of the second spatial layer is associated with the set of resources.

Aspect 5: The method of any of aspects 1 through 4, wherein transmitting the control message comprises: transmitting a sidelink control message indicating that at least one subchannel of the second spatial layer corresponding to the set of resources includes a repetition of a subchannel of the first spatial layer, wherein the subchannel corresponds to the portion of the first data packet.

Aspect 6: The method of any of aspects 1 through 5, wherein transmitting the control message comprises: transmitting a sidelink control message indicating that a subchannel of the second spatial layer contains the mapped portion of the first data packet.

Aspect 7: The method of any of aspects 1 through 6, further comprising: transmitting the first data packet via the first spatial layer in a transmission time interval; transmitting the second data packet via the second spatial layer in the transmission time interval; and transmitting the portion of the first data packet via the second spatial layer in the transmission time interval.

Aspect 8: The method of any of aspects 1 through 7, further comprising: performing a channel sensing procedure on the first spatial layer; and determining the portion of the first data packet for mapping to the second spatial layer based at least in part on the channel sensing procedure.

Aspect 9: The method of aspect 8, wherein the portion of the first data packet determined for mapping to the second spatial layer corresponds to a subchannel of the first spatial layer associated with a highest interference measurement based at least in part on the channel sensing procedure.

Aspect 10: The method of any of aspects 1 through 9, further comprising: determining the portion of the first data packet for mapping, wherein the first portion of the data packet corresponds to a first subchannel of the first spatial layer different from a second subchannel of the first spatial layer that is allocated for transmission of the control message.

Aspect 11: The method of any of aspects 1 through 10, further comprising: appending the portion of the first data packet to the second data packet before transmission of the first and second data packets.

Aspect 12: The method of aspect 11, wherein transmitting the control message comprises: transmitting a sidelink control message indicating a boundary between the second data packet and the portion of the first data packet based at least in part on the appending.

Aspect 13: The method of aspect 12, wherein the boundary is indicated via a medium access control (MAC) control element (MAC-CE).

Aspect 14: The method of any of aspects 11 through 13, further comprising: generating an error correction or detection code of the second data packet and the appended portion of the first data packet; and transmitting a message via the second spatial layer that includes the second data packet, the appended portion of the first data packet, and the error correction or detection code.

Aspect 15: The method of any of aspects 1 through 14, further comprising: generating a first error correction or detection code for the portion of the first data packet; generating a second error correction or detection code for the second data packet; appending the portion of the first data packet and the first error correction or detection code to the second data packet and the second error correction or detection code; and transmitting a message via the second spatial layer that includes the second data packet, the second error correction or detection code, the appended portion of the first data packet, and the appended first error correction or detection code.

Aspect 16: The method of aspect 15, further comprising: generating a combined error correction or detection code for a combination of the second data packet, the second error correction or detection code, the appended portion of the first data packet, and the appended first error correction or detection code, wherein the message includes the combined error correction or detection code.

Aspect 17: The method of any of aspects 1 through 16, further comprising: transmitting an indication of a presence or absence of an error correction or detection code for the portion of the first data packet.

Aspect 18: The method of any of aspects 1 through 17, further comprising: mapping a set of reference signal symbols across all resources allocated to the first spatial layer and all resources allocated to the second spatial layer.

Aspect 19: The method of aspect 18, further comprising: mapping a first reference signal to a subset of the resources allocated to the first spatial layer according to a first reference signal pattern for the first spatial layer; and mapping a second reference signal to resources allocated to the second spatial layer including the set of resources according to a second reference signal pattern for the second spatial layer.

Aspect 20: The method of any of aspects 1 through 19, further comprising: determining a first packet size of the first data packet for transmission using the first spatial layer based at least in part on a first modulation and coding scheme associated with the first data packet; determining a second packet size of the second data packet for transmission using the second spatial layer based at least in part on a second modulation and coding scheme associated with the second data packet; and determining to map the portion of the first data packet to the second spatial layer based at least in part on the first packet size being greater than the second packet size.

Aspect 21: The method of any of aspects 1 through 20, further comprising: determining a first number of subchannels for transmission of the first data packet using the first spatial layer; determining a second number of subchannels for transmission of the second data packet using the second spatial layer; and determining to map the portion of the first data packet to the second spatial layer based at least in part on the first number of subchannels being greater than the second number of subchannels.

Aspect 22: A method for wireless communications at a first UE, comprising: receiving, from a second UE, an indication that a portion of a first data packet for transmission to the first UE is mapped to a second spatial layer, the first spatial layer associated with a first transmission reception point of the second UE and the second spatial layer associated with a second transmission reception point of the second UE; monitoring a set of resources of the second spatial layer for the portion of the first data packet, a second data packet, or both, wherein the set of resources at least partially overlaps resources allocated to the first spatial layer in time; and transmitting a feedback message for the portion of the first data packet or the second data packet based at least in part on monitoring the set of resources.

Aspect 23: The method of aspect 22, wherein transmitting the feedback message comprises: transmitting a negative acknowledgement message based at least in part on an unsuccessful decoding of the first layer.

Aspect 24: The method of aspect 23, further comprising: storing the portion of the first data packet received using the second spatial layer; and receiving a retransmission of the first data packet via the second transmission reception point of the second UE.

Aspect 25: The method of any of aspects 22 through 24, further comprising: receiving the first data packet using the first spatial layer; and combining, as part of a decoding procedure of the first data packet, the first data packet with the portion of the first data packet received using the second spatial layer.

Aspect 26: The method of any of aspects 22 through 25, further comprising: dropping the portion of the first data packet via the set of resources of the second spatial layer, wherein the feedback message is transmitted based at least in part on a result of a decoding procedure of the second data packet received using the second spatial layer.

Aspect 27: The method of any of aspects 22 through 26, wherein receiving the indication comprises: receiving a common control message via both the first spatial layer and the second spatial layer, the common control message indicating that the resources allocated to the first spatial layer are the same as resources allocated to the second spatial layer.

Aspect 28: The method of any of aspects 22 through 27, wherein receiving the indication comprises: receiving a common control message via each of the first spatial layer and the second spatial layer, the common control message indicating the set of resources of the second spatial layer being the same as a subset of the resources allocated to the first spatial layer.

Aspect 29: The method of any of aspects 22 through 28, wherein receiving the indication comprises: receiving a sidelink control message indicating that a part of the second spatial layer is a repetition of a part of the first spatial layer, wherein the part of the second spatial layer is associated with the set of resources.

Aspect 30: The method of any of aspects 22 through 29, wherein receiving the indication comprises: receiving a sidelink control message indicating that at least one subchannel of the second spatial layer corresponding to the set of resources includes a repetition of a subchannel of the first spatial layer, wherein the subchannel corresponds to the portion of the first data packet.

Aspect 31: The method of any of aspects 22 through 30, wherein receiving the indication comprises: receiving a sidelink control message indicating that a subchannel of the second spatial layer contains the mapped portion of the first data packet.

Aspect 32: The method of any of aspects 22 through 31, further comprising: receiving the first data packet via the first spatial layer in a transmission time interval; receiving the second data packet via the second spatial layer in the transmission time interval; and receiving the portion of the first data packet via the second spatial layer in the transmission time interval.

Aspect 33: The method of any of aspects 22 through 32, further comprising: receiving a sidelink control message indicating a boundary between the second data packet and the portion of the first data packet appended to the second data packet.

Aspect 34: The method of any of aspects 22 through 33, further comprising: receiving a message via the second spatial layer that includes the second data packet, the portion of the first data packet appended to the second data packet, and an error correction or detection code corresponding to the second data packet and the portion of the first data packet appended to the second data packet.

Aspect 35: The method of any of aspects 22 through 34, further comprising: receiving a message via the second spatial layer that includes the second data packet, a second error correction or detection code for the second data packet, the portion of the first data packet appended to the second data packet, and a first error correction or detection code for the portion of the first data packet appended to the second data packet.

Aspect 36: The method of any of aspects 22 through 35, further comprising: receiving an indication of a presence or absence of an error correction or detection code for the portion of the first data packet.

Aspect 37: An apparatus for wireless communications at a UE, comprising a processor; memory coupled with the processor; and instructions stored in the memory and executable by the processor to cause the apparatus to perform a method of any of aspects 1 through 21.

Aspect 38: An apparatus for wireless communications at a UE, comprising at least one means for performing a method of any of aspects 1 through 21.

Aspect 39: A non-transitory computer-readable medium storing code for wireless communications at a UE, the code comprising instructions executable by a processor to perform a method of any of aspects 1 through 21.

Aspect 40: An apparatus for wireless communications at a first UE, comprising a processor; memory coupled with the processor; and instructions stored in the memory and executable by the processor to cause the apparatus to perform a method of any of aspects 22 through 36.

Aspect 41: An apparatus for wireless communications at a first UE, comprising at least one means for performing a method of any of aspects 22 through 36.

Aspect 42: A non-transitory computer-readable medium storing code for wireless communications at a first UE, the code comprising instructions executable by a processor to perform a method of any of aspects 22 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
identify a first data packet for transmission using a first spatial layer and a second data packet for transmission using a second spatial layer, the first spatial layer associated with a first transmission reception point of the UE and the second spatial layer associated with a second transmission reception point of the UE;
map a portion of the first data packet to a set of resources of the second spatial layer, the set of resources at least partially overlapping in time with resources allocated to the first spatial layer; and
transmit a control message indicating that the portion of the first data packet is mapped to the second spatial layer.

2. The apparatus of claim 1, wherein the instructions to transmit the control message are executable by the processor to cause the apparatus to:
transmit a common control message via both the first spatial layer and the second spatial layer, the common control message indicating that the resources allocated to the first spatial layer are the same as resources allocated to the second spatial layer.

3. The apparatus of claim 1, wherein the instructions to transmit the control message are executable by the processor to cause the apparatus to:
transmit a common control message via each of the first spatial layer and the second spatial layer, the common control message indicating the set of resources of the second spatial layer being the same as a subset of the resources allocated to the first spatial layer.

4. The apparatus of claim 1, wherein the instructions to transmit the control message are executable by the processor to cause the apparatus to:
transmit a sidelink control message indicating that a part of the second spatial layer is a repetition of a part of the first spatial layer, wherein the part of the second spatial layer is associated with the set of resources.

5. The apparatus of claim 1, wherein the instructions to transmit the control message are executable by the processor to cause the apparatus to:
transmit a sidelink control message indicating that at least one subchannel of the second spatial layer corresponding to the set of resources includes a repetition of a subchannel of the first spatial layer, wherein the subchannel corresponds to the portion of the first data packet.

6. The apparatus of claim 1, wherein the instructions to transmit the control message are executable by the processor to cause the apparatus to:
transmit a sidelink control message indicating that a subchannel of the second spatial layer contains the mapped portion of the first data packet.

7. The apparatus of claim 1, wherein the instructions are further executable by the processor to cause the apparatus to:
transmit the first data packet via the first spatial layer in a transmission time interval;
transmit the second data packet via the second spatial layer in the transmission time interval; and
transmit the portion of the first data packet via the second spatial layer in the transmission time interval.

8. The apparatus of claim 1, wherein the instructions are further executable by the processor to cause the apparatus to:
perform a channel sensing procedure on the first spatial layer; and
determine the portion of the first data packet for mapping to the second spatial layer based at least in part on the channel sensing procedure.

9. The apparatus of claim 8, wherein the portion of the first data packet determined for mapping to the second spatial layer corresponds to a subchannel of the first spatial layer associated with a highest interference measurement based at least in part on the channel sensing procedure.

10. The apparatus of claim 1, wherein the instructions are further executable by the processor to cause the apparatus to:
determine the portion of the first data packet for mapping, wherein the first portion of the data packet corresponds to a first subchannel of the first spatial layer different from a second subchannel of the first spatial layer that is allocated for transmission of the control message.

11. The apparatus of claim 1, wherein the instructions are further executable by the processor to cause the apparatus to:
append the portion of the first data packet to the second data packet before transmission of the first and second data packets.

12. The apparatus of claim 11, wherein the instructions to transmit the control message are executable by the processor to cause the apparatus to:
transmit a sidelink control message indicating a boundary between the second data packet and the portion of the first data packet based at least in part on the appending.

13. The apparatus of claim 12, wherein the boundary is indicated via a medium access control (MAC) control element (MAC-CE).

14. The apparatus of claim 11, wherein the instructions are further executable by the processor to cause the apparatus to:
generate an error correction or detection code of the second data packet and the appended portion of the first data packet; and
transmit a message via the second spatial layer that includes the second data packet, the appended portion of the first data packet, and the error correction or detection code.

15. The apparatus of claim 1, wherein the instructions are further executable by the processor to cause the apparatus to:
generate a first error correction or detection code for the portion of the first data packet;
generate a second error correction or detection code for the second data packet;
append the portion of the first data packet and the first error correction or detection code to the second data packet and the second error correction or detection code; and
transmit a message via the second spatial layer that includes the second data packet, the second error correction or detection code, the appended portion of the first data packet, and the appended first error correction or detection code.

16. The apparatus of claim 15, wherein the instructions are further executable by the processor to cause the apparatus to:
generate a combined error correction or detection code for a combination of the second data packet, the second error correction or detection code, the appended portion of the first data packet, and the appended first error correction or detection code, wherein the message includes the combined error correction or detection code.

17. The apparatus of claim 1, wherein the instructions are further executable by the processor to cause the apparatus to:
transmit an indication of a presence or absence of an error correction or detection code for the portion of the first data packet.

18. The apparatus of claim 1, wherein the instructions are further executable by the processor to cause the apparatus to:
map a set of reference signal symbols across all resources allocated to the first spatial layer and all resources allocated to the second spatial layer.

19. The apparatus of claim 18, wherein the instructions are further executable by the processor to cause the apparatus to:
map a first reference signal to a subset of the resources allocated to the first spatial layer according to a first reference signal pattern for the first spatial layer; and
map a second reference signal to resources allocated to the second spatial layer including the set of resources according to a second reference signal pattern for the second spatial layer.

20. The apparatus of claim 1, wherein the instructions are further executable by the processor to cause the apparatus to:
determine a first packet size of the first data packet for transmission using the first spatial layer based at least in part on a first modulation and coding scheme associated with the first data packet;
determine a second packet size of the second data packet for transmission using the second spatial layer based at least in part on a second modulation and coding scheme associated with the second data packet; and
determine to map the portion of the first data packet to the second spatial layer based at least in part on the first packet size being greater than the second packet size.

21. The apparatus of claim 1, wherein the instructions are further executable by the processor to cause the apparatus to:
determine a first number of subchannels for transmission of the first data packet using the first spatial layer;
determine a second number of subchannels for transmission of the second data packet using the second spatial layer; and
determine to map the portion of the first data packet to the second spatial layer based at least in part on the first number of subchannels being greater than the second number of subchannels.

22. An apparatus for wireless communications at a first user equipment (UE), comprising:
a processor;
memory coupled with the processor; and
instructions stored in the memory and executable by the processor to cause the apparatus to:
receive, from a second UE, an indication that a portion of a first data packet for transmission to the first UE is mapped to a second spatial layer, the first spatial layer associated with a first transmission reception point of the second UE and the second spatial layer associated with a second transmission reception point of the second UE;
monitor a set of resources of the second spatial layer for the portion of the first data packet, a second data packet, or both, wherein the set of resources at least partially overlaps resources allocated to the first spatial layer in time; and
transmit a feedback message for the portion of the first data packet or the second data packet based at least in part on monitoring the set of resources.

23. The apparatus of claim 22, wherein the instructions to transmit the feedback message are executable by the processor to cause the apparatus to:
transmit a negative acknowledgement message based at least in part on an unsuccessful decoding of the first layer.

24. The apparatus of claim 23, wherein the instructions are further executable by the processor to cause the apparatus to:
store the portion of the first data packet received using the second spatial layer; and
receive a retransmission of the first data packet via the second transmission reception point of the second UE.

25. The apparatus of claim 22, wherein the instructions are further executable by the processor to cause the apparatus to:
receive the first data packet using the first spatial layer; and
combine, as part of a decoding procedure of the first data packet, the first data packet with the portion of the first data packet received using the second spatial layer.

26. The apparatus of claim 22, wherein the instructions are further executable by the processor to cause the apparatus to:
drop the portion of the first data packet via the set of resources of the second spatial layer, wherein the feedback message is transmitted based at least in part on a result of a decoding procedure of the second data packet received using the second spatial layer.

27. The apparatus of claim 22, wherein the instructions to receive the indication are executable by the processor to cause the apparatus to:
receive a common control message via both the first spatial layer and the second spatial layer, the common control message indicating that the resources allocated to the first spatial layer are the same as resources allocated to the second spatial layer.

28. The apparatus of claim 22, wherein the instructions to receive the indication are executable by the processor to cause the apparatus to:
receive a common control message via each of the first spatial layer and the second spatial layer, the common control message indicating the set of resources of the second spatial layer being the same as a subset of the resources allocated to the first spatial layer.

29. A method for wireless communications at a user equipment (UE), comprising:
identifying a first data packet for transmission using a first spatial layer and a second data packet for transmission using a second spatial layer, the first spatial layer associated with a first transmission reception point of the UE and the second spatial layer associated with a second transmission reception point of the UE;
mapping a portion of the first data packet to a set of resources of the second spatial layer, the set of resources at least partially overlapping in time with resources allocated to the first spatial layer; and
transmitting a control message indicating that the portion of the first data packet is mapped to the second spatial layer.

30. A method for wireless communications at a first user equipment (UE), comprising:
receiving, from a second UE, an indication that a portion of a first data packet for transmission to the first UE is mapped to a second spatial layer, the first spatial layer associated with a first transmission reception point of the second UE and the second spatial layer associated with a second transmission reception point of the second UE;
monitoring a set of resources of the second spatial layer for the portion of the first data packet, a second data packet, or both, wherein the set of resources at least partially overlaps resources allocated to the first spatial layer in time; and
transmitting a feedback message for the portion of the first data packet or the second data packet based at least in part on monitoring the set of resources.
